(19) United States
(12) Patent Application Publication
(10) Pub. No.: US 2025/0057191 A1
(43) Pub. Date: Feb. 20, 2025

(54) METHODS OF IMPROVING THE NUTRITIONAL STATUS OF IMMUNE STRESSED ANIMALS

(71) Applicant: ELANCO US INC., Greenfield, IN (US)

(72) Inventors: Kim FRIESEN, Carthage, IN (US); Ran SONG, Eden Prairie, MN (US); Robert MUSSER, Good Thunder, MN (US)

(21) Appl. No.: 18/720,408

(22) PCT Filed: Dec. 19, 2022
(86) PCT No.: PCT/US2022/081979

§ 371 Date: Jun. 14, 2024

Related U.S. Application Data
(60) Provisional application No. 63/290,876, filed on Dec. 17, 2021.

(51) Int. Cl. A23K 20/163; A23K 10/18; A23K 20/142; A23K 50/30

(52) U.S. Cl. CPC A23K 20/163; A23K 10/18; A23K 20/142; A23K 50/30

(57) ABSTRACT

Disclosed are compositions comprising a composition comprising beta-glucan, yeast cell wall, direct fed microbials (Yeast+DFM), and L-carnitine and methods of using the compositions for improving the nutritional status, improving growth performance and survivability in an animal by administering the composition to the animal. Importantly, administering the Yeast+DFM in combination with L-carnitine results in a synergistic restoration of the insufficient level of circulating vitamin A in the animal.

### CROSS-REFERENCE TO RELATED APPLICATIONS

This application claims priority from Provisional Application No. 63/290,876, filed Dec. 17, 2021, the entire contents of which are hereby incorporated by reference.

### FIELD OF THE INVENTION

Compositions and methods of using the compositions for improving the nutritional status of an animal are disclosed.

### BACKGROUND OF THE INVENTION

The demand for food and food products from animal husbandry is anticipated to increase significantly as the population is growing. In commercial swine operations, fast-growing animals are more profitable and weight gain can be directly influenced by the animal's nutritional status.

Specifically, in pigs, nutritional status of retinol, as measured by serum concentration of vitamin A, is positively correlated with growth rate and livability in nursing pigs prior to weaning and in pigs post weaning. However, although dietary supplementations of nutrients, such as vitamin A, is adequate based on nutrient requirement determined by National Research Council (NRC; 2012), nutrient insufficiency still occurs under immunological challenges, including but not limited to physical, psychological, and environmental stress, viral infections like PRRS, SIV, and bacterial infections like E. coli and Salmonella. Pigs react to these immunological stresses by mounting an immune responses, which diverts nutrients from growth to the immune system, and reducing feed consumption, which further reduces nutrient intake. These physiological reactions cause nutrient deficiency under immunological stress. Many times, simply increasing dietary nutrient supply does not overcome these challenges.

To address these challenges, what is needed is a feed additive to restore vitamin A status and negate the negative impact of up regulating the immune system on growth and survivability.

### SUMMARY OF THE INVENTION

One aspect of the instant disclosure encompasses a method of improving a nutritional status of an immunologically stressed non-human animal in need thereof. The method comprises orally administering to the animal a composition comprising beta-glucan, yeast cell wall, direct fed microbials (Yeast+DFM), and L-carnitine, wherein improving the nutritional status of the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal.

In some aspects, the insufficient levels of vitamin A are below about 0.15 ppm and the sufficient levels of vitamin A are about 0.15 ppm or above, from about 0.15 ppm to about 0.2 ppm, or about 0.2 ppm or above.

The animal can be an immunologically stressed animal in response a challenge. In some aspects, the animal is immunologically stressed in response to a stressor selected from microbial infection, induced inflammation (vaccination), psychological trauma (weaning), and physical trauma. In some aspects, the animal is immunologically stressed in response to weaning. In some aspects, the animal is immunologically stressed in response to vaccination.

The composition can be administered to the animal starting at weaning. In some aspects, administering the Yeast+DFM in combination with L-carnitine to the animal improves growth performance and survivability of the animal. In some aspects, growth performance comprises ADG and feed conversion

In some aspects, the animal is a pig. When the animal is a pig, the feed composition can comprise Yeast, DFM, L-carnitine at rates of about 89%, about 1%, about 10% respectively in the supplement. In some aspects, the composition is administered in a feed composition at an inclusion rate ranging from about 0.3 lb/ton to about 0.6 lb/ton, or at an inclusion rate ranging from about 0.9 lb/ton to about 1.1 lb/ton.

Another aspect of the instant disclosure encompasses a method of improving growth performance and survivability of an animal in need thereof. The method comprises orally administering to the animal a composition comprising beta-glucan, yeast cell wall, direct fed microbials (Yeast+DFM), and L-carnitine, wherein improving growth performance and survivability of the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal. In some aspects, the animal is immunologically stressed.

An additional aspect of the instant disclosure encompasses a method of reducing immunological stress in an animal in need thereof. The method comprises orally administering to the animal a composition comprising beta-glucan, yeast cell wall, direct fed microbials (Yeast+DFM), and L-carnitine, wherein reducing immunological stress in the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal. In some aspects, the animal is immunologically stressed.

One aspect of the instant disclosure encompasses a method of predicting the growth potential and survivability of an animal. The method comprises measuring the level of circulating vitamin A, correlating the level of circulating vitamin A with the growth potential. The level of circulating vitamin positively correlates with growth potential and survivability.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 depicts a plot showing serum vitamin A concentrations in pigs pre- and post-weaning.

FIG. 2 depicts a plot showing the correlation between concentrations of serum vitamin A and C-reactive protein at weaning.

FIG. 3 depicts a plot showing the variations of serum vitamin A concentrations in pigs pre-and post-weaning by dietary treatment.

FIG. 4 depicts a plot showing the correlation between serum vitamin A and feed efficiency in growing pigs (60 to 200 lb of BW).

FIG. 5 depicts a plot showing the correlation between serum vitamin A and removal rate in growing pigs (60 to 200 lb of BW).

FIG. 6 depicts a plot showing changes of serum vitamin A concentration in nursery pigs fed full or partial compositions of a beta-glucan/yeast cell wall/direct fed microbials/L-carnitine combination (Combo) from weaning to end of nursery phase.

### DETAILED DESCRIPTION

The present disclosure is based on the discovery that orally administering to immunologically stressed non-human animals a composition comprising beta-glucan, yeast cell wall, direct fed microbials (Yeast+DFM), and L-carnitine improves the nutritional status, increases growth performance, and reduces mortality of the immunologically stressed non-human animals

Importantly, the inventors surprisingly discovered that administering the Yeast+DFM in combination with L-carnitine to the immunologically stressed non-human animals results in a synergistic improvement in the nutritional status, growth performance, and survivability of the animals. This is because animals fed the Yeast+DFM in combination with L-carnitine exhibit higher levels of improvement that is greater than the predicted improvements produced by administering Yeast+DFM or L-carnitine separately.

### I. Feed Composition

One aspect of the present disclosure encompasses feed compositions for non-human animals. The compositions comprise a basal animal diet supplemented with a formulated yeast and “direct fed microbial” (Yeast+DFM), in combination with L-carnitine. The concentration of Yeast, DFM, L-carnitine are 89%, 1%, 10% respectively in the supplement.

### (a) Direct Fed Microbial (DFM)

As used herein, the term “direct fed microbial” (DFM) is used to refer to a probiotic or prebiotic living microorganisms that provide health benefits when ingested by an animal. DFMs can include yeast, bacteria, and combinations thereof.

By way of non-limiting example, yeast DFMs can comprise Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Candida albicans, Candida cloaceae, Candida tropicalis, Candida utilis, Geotrichum candidum, Hansenula americana, Hansenula anomala, Hansenula wingei, and Aspergillus oryzae.

Non-limiting examples of bacterial DFMs include Lactobacillus acidophilus, Bifedobact thermophilum, Bifedobat longhum, Streptococcus faecium, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacterium freudenreichii, and Bifidobacterium pscudolongum.

The amount of DFM in a feed composition can and will vary depending on the DFM, the type of non-human animal that will be administered the feed composition, the body weight, sex, and medical condition of the non-human animal among other variables, and can be determined experimentally. Preferably, a DFM suitable for feed compositions of the disclosure is Bacillus licheniformis. When a DFM of a feed composition is Bacillus licheniformis, the concentration of Bacillus licheniformis in the feed composition can range from about 1×10¹ cfu/g of feed to about 1×10¹⁰ cfu/g of feed, from about 1×10¹ cfu/g of feed to about 1×10⁶ cfu/g of feed, from about 1×10⁵ cfu/g of feed to about 1×10¹⁰ cfu/g of feed, or from about 1×10³ cfu/g of feed to about 1×10⁸ cfu/g of feed. Preferably, the concentration of Bacillus licheniformis is about 1×10⁴ to about 1×10⁶ cfu/g feed.

### (b) Formulated Yeast

As used herein, formulated yeast can comprise a combination of Saccharomyces cerevisiae yeast extract representing approximately 25-100% of the total formulated yeast by weight, hydrolyzed yeast representing approximately 0-40% of the total formulated yeast by weight, a yeast culture representing approximately 0-50% of the total formulated yeast by weight. The formulated yeast can also comprise limestone representing approximately 0-50% of the total formulated yeast by weight.

The formulated yeast can be any yeast provided the yeast is generally regarded as safe for use in food or medical applications. Non-limiting examples of formulated yeast-derived products can include yeast cell wall derived components such as β-glucans, arabinoxylan isomaltose, agarooligosaccharides, lactosucrose, cyclodextrins, lactose, fructooligosaccharides, laminariheptaose, lactulose, β-galactooligosaccharides, mannanoligosaccharides, raffinose, stachyose, oligofructose, glucosyl sucrose, sucrose thermal oligosaccharide, isomalturose, caramel, inulin, and xylooligosaccharides. In an aspect, the formulated yeast can be β-glucans and/or mannanoligosaccharides. Sources for yeast cell wall derived components include Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Candida albicans, Candida cloaceae, Candida tropicalis, Candida utilis, Geotrichum candidum, Hansenula americana, Hansenula anomala, Hansenula wingei, and Aspergillus oryzae.

The formulated yeast can also include bacteria cell wall derived agents such as peptidoglycan and other components derived from gram-positive bacteria with a high content of peptidoglycan. Exemplary gram-positive bacteria include Lactobacillus acidophilus, Bifedobact thermophilum, Bifedobat longhum, Streptococcus faecium, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacterium freudenreichii, and Bifidobacterium pseudolongum.

The concentration of formulated yeast in a feed composition of the instant disclosure can and will vary depending on the formulated yeast, the type of non-human animal that will be administered the feed composition, the body weight, sex, and medical condition of the non-human animal among other variables, and can be determined experimentally. For instance, the concentration of formulated yeast in the feed composition can range from about 0.01 lb/ton of feed to about 1 lb/ton of feed, from about 0.1 lb/ton of feed to about 2 lb/ton of feed, from about 0.5 lb/ton of feed to about 1 lb/ton of feed, or from about 0.1 lb/ton of feed to about 1 lb/ton of feed. In some aspects, the concentration of capsicum product in the feed composition ranges from about 0.3 lb/ton of feed to about 1.0 lb/ton of feed.

### (c) Basal Animal Diet

A basal animal diet suitable for a feed composition of the instant disclosure can and will vary depending on the intended animal, the weight of the animal, and the stage of development of the animal among other variables.

The terms “feed”, “food”, and “feed formulation” are used herein interchangeably and can refer to any feed composition normally fed to an animal. Basal animal diets normally fed to an animal are known in the art. A basal animal diet can include one or more components of an animal feed. Non-limiting examples of feed matter or animal feed matter can include, without limitation: corn or a component of corn, such as, for example, corn meal, corn fiber, corn hulls, corn DDGS (distiller's dried grain with solubles), silage, ground corn, corn germ, corn gluten, corn oil, or any other portion of a corn plant; soy or a component of soy, such as, for example, soy oil, soy meal, soy hulls, soy silage, ground soy, or any other portion of a soy plant; wheat or any component of wheat, such as, for example, wheat meal, wheat fiber, wheat hulls, wheat chaff, ground wheat, wheat germ, or any other portion of a wheat plant; rice or any component of rice, such as, for example, rice meal, rice fiber, rice hulls, rice chaff, ground rice, rice germ, or any other portion of a rice plant; canola, such as, for example, canola oil, canola meal, canola protein, canola hulls, ground canola, or any other portion of a canola plant; sunflower or a component of a sunflower plant; sorghum or a component of a sorghum plant; sugar beet or a component of a sugar beet plant; cane sugar or a component of a sugarcane plant; barley or a component of a barley plant; palm oil, palm kernel or a component of a palm plant; glycerol; corn steep liquor; a waste stream from an agricultural processing facility; lecithin; rumen protected fats; molasses; soy molasses; flax; peanuts; peas; oats; grasses, such as orchard grass and fescue; fish meal, meat & bone meal; feather meal; and poultry byproduct meal; and alfalfa and/or clover used for silage or hay, and various combinations of any of the feed ingredients set forth herein, or other feed ingredients generally known in the art. As it will be recognized in the art, a basal animal diet can further be supplemented with amino acids, vitamins, minerals, and other feed additives such as other types of enzymes, organic acids, essential oils, probiotics, prebiotics, antioxidants, pigments, anti-caking agents, and the like, as described further below. A basal animal diet can be formulated for administration to any animal subject. Animal subjects can be as described below.

The basal animal diets can optionally comprise at least one additional nutritive and/or pharmaceutical agent. For instance, the at least one additional nutritive and/or pharmaceutical agent can be selected from the group consisting of vitamin, mineral, amino acid, antioxidant, probiotic, essential fatty acid, and pharmaceutically acceptable excipient. The compositions can include one additional nutritive and/or pharmaceutical component or a combination of any of the foregoing additional components in varying amounts. Suitable examples of each additional component are detailed below.

### A. Vitamins

Optionally, the animal feed formulation can include one or more vitamins. Suitable vitamins for use in the dietary supplement include vitamin C, vitamin A, vitamin E, vitamin B12, vitamin K, riboflavin, niacin, vitamin D, vitamin B6, folic acid, pyridoxine, thiamine, pantothenic acid, and biotin. The form of the vitamin can include salts of the vitamin, derivatives of the vitamin, compounds having the same or similar activity of a vitamin, and metabolites of a vitamin.

The animal feed formulation can include one or more forms of an effective amount of any of the vitamins described herein or otherwise known in the art. Exemplary vitamins include vitamin K, vitamin D, vitamin C, and biotin. An “effective amount” of a vitamin typically quantifies an amount at least about 10% of the United States Recommended Daily Allowance (“RDA”) of that particular vitamin for a subject. It is contemplated, however, that amounts of certain vitamins exceeding the RDA can be beneficial for certain animals. For example, the amount of a given vitamin can exceed the applicable RDA by 100%, 200%, 300%, 400%, 500% or more.

### B. Minerals

Generally, the animal feed formulation can include one or more minerals or mineral sources. Non-limiting examples of minerals include, without limitation, calcium, iron, chromium, copper, iodine, zinc, magnesium, manganese, molybdenum, phosphorus, potassium, and selenium. Suitable forms of any of the foregoing minerals include soluble mineral salts, slightly soluble mineral salts, insoluble mineral salts, chelated minerals, mineral complexes, non-reactive minerals such as carbonyl minerals, and reduced minerals, and combinations thereof.

Generally speaking, the animal feed formulation can include one or more forms of an effective amount of any of the minerals described herein or otherwise known in the art. An “effective amount” of a mineral typically quantifies an amount at least about 10% of the United States Recommended Daily Allowance (“RDA”) of that particular mineral for a subject. It is contemplated, however, that amounts of certain minerals exceeding the RDA can be beneficial for certain subjects. For example, the amount of a given mineral can exceed the applicable RDA by 100%, 200%, 300%, 400%, 500% or more. Typically, the amount of mineral included in the dietary supplement can range from about 1 mg to about 1500 mg, about 5 mg to about 500 mg, or from about 50 mg to about 500 mg per dosage.

### C. Essential Fatty Acids

Optionally, the animal feed formulation can include a source of an essential fatty acid. The essential fatty acid can be isolated or it can be an oil source or fat source that contains an essential fatty acid. In one aspect, the essential fatty acid can be a polyunsaturated fatty acid (PUFA), which has at least two carbon-carbon double bonds generally in the cis-configuration. The PUFA can be a long chain fatty acid having at least 18 carbons atoms. The PUFA can be an omega-3 fatty acid in which the first double bond occurs in the third carbon-carbon bond from the methyl end of the carbon chain (i.e., opposite the carboxyl acid group). Examples of omega-3 fatty acids include alpha-linolenic acid (18:3, ALA), stearidonic acid (18:4), eicosatetraenoic acid (20:4), eicosapentaenoic acid (20:5; EPA), docosatetraenoic acid (22:4), n-3 docosapentaenoic acid (22:5; n-3DPA). and docosahexaenoic acid (22:6; DHA). The PUFA can also be an omega-5 fatty acid, in which the first double bond occurs in the fifth carbon-carbon bond from the methyl end. Exemplary omega-5 fatty acids include myristoleic acid (14:1), myristoleic acid esters, and cetyl myristoleate. The PUFA can also be an omega-6 fatty acid, in which the first double bond occurs in the sixth carbon-carbon bond from the methyl end. Examples of omega-6 fatty acids include linoleic acid (18:2), gamma-linolenic acid (18:3), eicosadienoic acid (20:2), dihomo-gamma-linolenic acid (20:3), arachidonic acid (20:4), docosadienoic acid (22:2), adrenic acid (22:4), and n-6 docosapentaenoic acid (22:5). The fatty acid can also be an omega-9 fatty acid, such as oleic acid (18:1), eicosenoic acid (20:1), mead acid (20:3), erucic acid (22:1), and nervonic acid (24:1).

In another aspect, the essential fatty acid source can be a seafood-derived oil. The seafood can be a vertebrate fish or a marine organism, such that the oil can be fish oil or marine oil. The long chain (20C, 22C) omega-3 and omega-6 fatty acids are found in seafood. The ratio of omega-3 to omega-6 fatty acids in seafood ranges from about 8:1 to 20:1. Seafood from which oil rich in omega-3 fatty acids can be derived include, but are not limited to, abalone scallops, albacore tuna, anchovies, catfish, clams, cod, gem fish, herring, lake trout, mackerel, menhaden, orange roughy, salmon, sardines, sea mullet, sea perch, shark, shrimp, squid, trout, and tuna.

In yet another aspect, the essential fatty acid source can be a plant-derived oil. Plant and vegetable oils are rich in omega-6 fatty acids. Some plant-derived oils, such as flaxseed oil, are especially rich in omega-3 fatty acids. Plant or vegetable oils are generally extracted from the seeds of a plant, but can also be extracted from other parts of the plant. Plant or vegetable oils that are commonly used for cooking or flavoring include, but are not limited to, acai oil, almond oil, amaranth oil, apricot seed oil, argan oil, avocado seed oil, babassu oil, ben oil, blackcurrant seed oil, Borneo tallow nut oil, borage seed oil, buffalo gourd oil, canola oil, carob pod oil, cashew oil, castor oil, coconut oil, coriander seed oil, corn oil, cottonseed oil, evening primrose oil, false flax oil, flax seed oil, grapeseed oil, hazelnut oil, hemp seed oil, kapok seed oil, lallemantia oil, linseed oil, macadamia oil, meadowfoam seed oil, mustard seed oil, okra seed oil, olive oil, palm oil, palm kernel oil, peanut oil, pecan oil, pequi oil, perilla seed oil, pine nut oil, pistachio oil, poppy seed oil, prune kernel oil, pumpkin seed oil, quinoa oil, ramtil oil, rice bran oil, safflower oil, sesame oil, soybean oil, sunflower oil, tea oil, thistle oil, walnut oil, or wheat germ oil. The plant-derived oil can also be hydrogenated or partially hydrogenated.

In still a further aspect, the essential fatty acid source can be an algae-derived oil. Commercially available algae-derived oils include those from Crypthecodinium cohnii and Schizochytrium sp. Other suitable species of algae, from which oil is extracted, include Aphanizomenon flos-aquae, Bacilliarophy sp., Botryococcus braunii, Chlorophyceae sp., Dunaliella tertiolecta, Euglena gracilis, Isochrysis galbana, Nannochloropsis salina, Nannochloris sp., Neochloris oleoabundans, Phaeodactylum tricornutum, Pleurochrysis carterae, Prymnesium parvum, Scenedesmus dimorphus, Spirulina sp., and Tetraselmis chui.

### D. Amino Acids

The animal feed formulation can optionally include from one to several amino acids. Suitable amino acids include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine or their hydroxy analogs. In certain aspects, the amino acid will be selected from the essential amino acids. An essential amino acid is generally described as one that cannot be synthesized de novo by the organism, and therefore, must be provided in the diet. By way of non-limiting example, the essential amino acids for humans include: L-histidine, L-isoleucine, L-leucine, L-lysine, L-methionine, L-phenylalanine, L-valine and L-threonine.

### E. Antioxidants

The animal feed formulation can include one or more suitable antioxidants. As will be appreciated by a skilled artisan, the suitability of a given antioxidant will vary depending upon the species to which the dietary supplement will be administered. Non-limiting examples of antioxidants include ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, p-coumaric acid, curcurin, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, propyl gallate, polyphosphates, quercetin, trans-resveratrol, rosmarinic acid, sesamol, silymarin, sinapic acid, succinic acid, stearyl citrate, syringic acid, tartaric acid, thymol, tocopherols (i.e., alpha-, beta-, gamma-and delta-tocopherol), tocotrienols (i.e., alpha-, beta-, gamma-and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, zeaxanthin, or combinations thereof.

Natural antioxidants that can be included in the dietary supplement include, but are not limited to, apple peel extract, blueberry extract, carrot juice powder, clove extract, coffee berry, coffee bean extract, cranberry extract, eucalyptus extract, ginger powder, grape seed extract, green tea, olive leaf, parsley extract, peppermint, pimento extract, pomace, pomegranate extract, rice bran extract, rosehips, rosemary extract, sage extract, tart cherry extract, tomato extract, turmeric, and wheat germ oil.

### F. Anti-Inflammatory Agents

The animal feed formulation can optionally include at least one anti-inflammatory agent. In one aspect, the anti-inflammatory agent can be a synthetic non-steroidal anti-inflammatory drug (NSAID) such as acetylsalicylic acid, dichlophenac, indomethacin, oxamethacin, ibuprofen, indoprofen, naproxen, ketoprofen, mefamanic acid, metamizole, piroxicam, and celecoxib. In an alternate aspect, the anti-inflammatory agent can be a prohormone that modulates inflammatory processes. Suitable prohormones having this property include prohormone convertase 1, proopiomelanocortin, prohormone B-type natriuretic peptide, SMR1 prohormone, and the like. In another aspect, the anti-inflammatory agent can be an enzyme having anti-inflammatory effects. Examples of anti-inflammatory enzymes include bromelain, papain, serrapeptidase, and proteolytic enzymes such as pancreatin (a mixture of trypsin, amylase and lipase).

In still another aspect, the anti-inflammatory agent can be a peptide with anti-inflammatory effects. For example, the peptide can be an inhibitor of phospholipase A2, such as antiflammin-1, a peptide that corresponds to amino acid residues 246-254 of lipocortin; antiflammin-2, a peptide that corresponds to amino acid residues 39-47 of uteroglobin; S7 peptide, which inhibits the interaction between interleukin 6 and interleukin 6 receptor; RP1, a prenyl protein inhibitor; and similar peptides. Alternatively, the anti-inflammatory peptide can be cortistatin, a cyclic neuropeptide related to somatostatin, or peptides that correspond to an N-terminal fragment of SV-IV protein, a conserved region of E-, L-, and P-selectins, and the like. Other suitable anti-inflammatory preparations include collagen hydrolysates and milk micronutrient concentrates (e.g., MicroLactin® available from Stolle Milk Biologics, Inc., Cincinnati, OH), as well as milk protein hydrolysates, casein hydrolysates, whey protein hydrolysates, and plant protein hydrolysates.

In a further aspect, the anti-inflammatory agent can be a probiotic that has been shown to modulate inflammation. Suitable immunomodulatory probiotics include lactic acid bacteria such as acidophilli, lactobacilli, and bifidophilli. In yet another aspect, the anti-inflammatory agent can be a plant extract having anti-inflammatory properties. Non-limiting examples of suitable plant extracts with anti-inflammatory benefits include blueberries, boswella, black catechu and Chinese skullcap, celery seed, chamomile, cherries, devil's claw, eucalyptus, evening primrose, ginger, hawthorne berries, horsetail, Kalopanax pictus bark, licorice root, turmeric, white wallow, willow bark, and yucca.

### G. Herbals

The animal feed formulation can optionally include at least one herb or herbal derivative. Suitable herbals and herbal derivatives, as used herein, refer to herbal extracts, and substances derived from plants and plant parts, such as leaves, flowers, and roots, without limitation. Non-limiting exemplary herbals and herbal derivatives include agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, cascara sagrada, catnip, celery, centaury, chamomile, chaparral, chickweed, chicory, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed. garlic, gentian, ginger, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. John's wort, sarsaparilla, sassafras, saw palmetto, skullcap, senega, senna, shepherd's purse, slippery elm, spearmint, spikenard, squawvine, stillingia, strawberry, taheebo, thyme, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca and combinations thereof.

### H. Pigments

The animal feed formulation can optionally include at least one pigment. Suitable non-limiting pigments include actinioerythrin, alizarin, alloxanthin, β-apo-2′-carotenal, apo-2-lycopenal, apo-6′-lycopenal, astacein, astaxanthin, azafrinaldehyde, aacterioruberin, aixin, α-carotine, β-carotine, γ-carotine, β-carotenone, canthaxanthin, capsanthin, capsorubin, citranaxanthin, citroxanthin, crocetin, crocetinsemialdehyde, crocin, crustaxanthin, cryptocapsin, α-cryptoxanthin, β-cryptoxanthin, cryptomonaxanthin, cynthiaxanthin, decaprenoxanthin, dehydroadonirubin, diadinoxanthin, 1,4-diamino-2,3-dihydroanthraquinone, 1,4-dihydroxyanthraquinone, 2,2′-diketospirilloxanthin, eschscholtzxanthin, eschscholtzxanthone, flexixanthin, foliachrome, fucoxanthin, gazaniaxanthin, hexahydrolycopene, hopkinsiaxanthin, hydroxyspheriodenone, isofucoxanthin, loroxanthin, lutein, luteoxanthin, lycopene, lycopersene, lycoxanthin, morindone, mutatoxanthin, neochrome, neoxanthin, nonaprenoxanthin, OH-Chlorobactene, okenone, oscillaxanthin, paracentrone, pectenolone, pectenoxanthin, peridinin, phleixanthophyll, phoeniconone, phoenicopterone, phoenicoxanthin, physalien, phytofluene, pyrrhoxanthininol, quinones, rhodopin, rhodopinal, rhodopinol, rhodovibrin, rhodoxanthin, rubixanthone, saproxanthin, semi-α-carotenone, semi-β-carotenone, sintaxanthin, siphonaxanthin, siphonein, spheroidene, tangeraxanthin, torularhodin, torularhodin methyl ester, torularhodinaldehyde, torulene, 1,2,4-trihydroxyanthraquinone, triphasiaxanthin, trollichrome, vaucheriaxanthin, violaxanthin, wamingone, xanthin, zeaxanthin, α-zeacarotene, or combinations thereof.

### I. Pharmaceutical Acceptable Agents

The animal feed formulation can optionally include at least one pharmaceutical acceptable agent. Suitable non-limiting pharmaceutically acceptable agents include an acid/alkaline-labile drug, a pH dependent drug, or a drug that is a weak acid or a weak base. Examples of acid-labile drugs include statins (e.g., pravastatin, fluvastatin and atorvastatin), antiobiotics (e.g., penicillin G, ampicillin, streptomycin, erythromycin, clarithromycin and azithromycin), nucleoside analogs (e.g., dideoxyinosine (ddI or didanosine), dideoxyadenosine (ddA), dideoxycytosine (ddC), salicylates (e.g., aspirin), digoxin, bupropion, pancreatin, midazolam, and methadone. Drugs that are only soluble at acid pH include nifedipine, emonapride, nicardipine, amosulalol, noscapine, propafenone, quinine, dipyridamole, josamycin, dilevalol, labetalol, enisoprost, and metronidazole. Drugs that are weak acids include phenobarbital, phenytoin, zidovudine (AZT), salicylates (e.g., aspirin), propionic acid compounds (e.g., ibuprofen), indole derivatives (e.g., indomethacin), fenamate compounds (e.g., meclofenamic acid), pyrrolealkanoic acid compounds (e.g., tolmetin), cephalosporins (e.g., cephalothin, cephalaxin, cefazolin, cephradine, cephapirin, cefamandole, and cefoxitin), 6-fluoroquinolones, and prostaglandins. Drugs that are weak bases include adrenergic agents (e.g., ephedrine, desoxyephedrine. phenylephrine, epinephrine, salbutamol, and terbutaline), cholinergic agents (e.g., physostigmine and neostigmine), antispasmodic agents (e.g., atropine, methantheline, and papaverine), curariform agents (e.g., chlorisondamine), tranquilizers and muscle relaxants (e.g., fluphenazine, thioridazine, trifluoperazine, chlorpromazine, and triflupromazine), antidepressants (e.g., amitriptyline and nortriptyline), antihistamines (e.g., diphenhydramine, chlorpheniramine, dimenhydrinate, tripelennamine, perphenazine, chlorprophenazine, and chlorprophenpyridamine), cardioactive agents (e.g., verapamil, diltiazem, gallapomil, cinnarizine, propranolol, metoprolol and nadolol), antimalarials (e.g., chloroquine), analgesics (e.g., propoxyphene and meperidine), antifungal agents (e.g., ketoconazole and itraconazole), antimicrobial agents (e.g., cefpodoxime, proxetil, and enoxacin), caffeine, theophylline, and morphine. In another aspect, the drug can be a biphosphonate or another drug used to treat osteoporosis. Non-limiting examples of a biphosphonate include alendronate, ibandronate, risedronate, zoledronate, pamidronate, neridronate, olpadronate, etidronate, clodronate, and tiludronate. Other suitable drugs include estrogen, selective estrogen receptor modulators (SERMs), and parathyroid hormone (PTH) drugs. In yet another aspect, the drug can be an antibacterial agent. Suitable antibiotics include aminoglycosides (e.g., amikacin, gentamicin, kanamycin, neomycin, netilmicin, streptomycin, and tobramycin), carbecephems (e.g., loracarbef), a carbapenem (e.g., certapenem, imipenem, and meropenem), cephalosporins (e.g., cefadroxil cefazolin, cephalexin, cefaclor, cefamandole, cephalexin, cefoxitin, cefprozil, cefuroxime, cefixime, cefdinir, cefditoren, cefoperazone, cefotaxime, cefpodoxime, ceftazidime, ceftibuten, ceftizoxime, and ceftriaxone), macrolides (e.g., azithromycin, clarithromycin, dirithromycin, erythromycin, and troleandomycin), monobactam, penicillins (e.g., amoxicillin, ampicillin, carbenicillin, cloxacillin, dicloxacillin, nafcillin, oxacillin, penicillin G, penicillin V, piperacillin, and ticarcillin), polypeptides (e.g., bacitracin, colistin, and polymyxin B), quinolones (e.g., ciprofloxacin, enoxacin, gatifloxacin, levofloxacin, lomefloxacin, moxifloxacin, norfloxacin, ofloxacin, and trovafloxacin), sulfonamides (e.g., mafenide, sulfacetamide, sulfamethizole, sulfasalazine, sulfisoxazole, and trimethoprim-sulfamethoxazole), and tetracyclines (e.g., demeclocycline, doxycycline, minocycline, and oxytetracycline). In an alternate aspect, the drug can be an antiviral protease inhibitor (e.g., amprenavir, fosamprenavir, indinavir, lopinavir/ritonavir, ritonavir, saquinavir, and nelfinavir). In still another aspect, the drug can be a cardiovascular drug. Examples of suitable cardiovascular agents include cardiotonic agents (e.g., digitalis (digoxin), ubidecarenone, and dopamine), vasodilating agents (e.g., nitroglycerin, captopril, dihydralazine, diltiazem, and isosorbide dinitrate), antihypertensive agents (e.g., alpha-methyldopa, chlortalidone, reserpine, syrosingopine, rescinnamine, prazosin, phentolamine, felodipine, propanolol, pindolol, labetalol, clonidine, captopril, enalapril, and lisonopril), beta blockers (e.g., levobunolol, pindolol, timolol maleate, bisoprolol, carvedilol, and butoxamine), alpha blockers (e.g., doxazosin, prazosin, phenoxybenzamine, phentolamine, tamsulosin, alfuzosin, and terazosin), calcium channel blockers (e.g., amlodipine, felodipine, nicardipine, nifedipine, nimodipine, nisoldipine, nitrendipine, lacidipine, lercanidipine, verapamil, gallopamil, and diltiazem), monensin, avilamycin, salinomycin, narasin, diclaserol, tylosin, bacitracin, bacitracin zinc, and anticlot agents (e.g., dipyrimadole).

### J. Excipients

A variety of commonly used excipients in animal feed formulation can be selected on the basis of compatibility with the active ingredients. Non-limiting examples of suitable excipients include an agent selected from the group consisting of non-effervescent disintegrants, a coloring agent, a flavor-modifying agent, an oral dispersing agent, a stabilizer, a preservative, a diluent, a compaction agent, a lubricant, a filler, a binder, taste masking agents, an effervescent disintegration agent, and combinations of any of these agents.

In one aspect, the excipient is a binder. Suitable binders include starches, pregelatinized starches, gelatin, polyvinylpyrolidone, cellulose, methylcellulose, sodium carboxymethylcellulose, ethylcellulose, polyacrylamides, polyvinyloxoazolidone, polyvinylalcohols, C12-C18 fatty acid alcohol, polyethylene glycol, polyols, saccharides, oligosaccharides, polypeptides, oligopeptides, and combinations thereof. The polypeptide can be any arrangement of amino acids ranging from about 100 to about 300,000 daltons.

In another aspect, the excipient can be a filler. Suitable fillers include carbohydrates, inorganic compounds, and polyvinylpirrolydone. By way of non-limiting example, the filler can be calcium sulfate, both di- and tri-basic, starch, calcium carbonate, magnesium carbonate, microcrystalline cellulose, dibasic calcium phosphate, magnesium carbonate, magnesium oxide, calcium silicate, talc, modified starches, lactose, sucrose, mannitol, and sorbitol.

The excipient can comprise a non-effervescent disintegrant. Suitable examples of non-effervescent disintegrants include starches such as corn starch, potato starch, pregelatinized and modified starches thereof, sweeteners, clays, such as bentonite, micro-crystalline cellulose, alginates, sodium starch glycolate, gums such as agar, guar, locust bean, karaya, pecitin, and tragacanth.

In another aspect, the excipient can be an effervescent disintegrant. By way of non-limiting example, suitable effervescent disintegrants include sodium bicarbonate in combination with citric acid and sodium bicarbonate in combination with tartaric acid.

The excipient can comprise a preservative. Suitable examples of preservatives include antioxidants, such as a-tocopherol or ascorbate, and antimicrobials, such as parabens, chlorobutanol or phenol.

In another aspect, the excipient can include a diluent. Diluents suitable for use include pharmaceutically acceptable saccharides such as sucrose, dextrose, lactose, microcrystalline cellulose, fructose, xylitol, and sorbitol; polyhydric alcohols; a starch; pre-manufactured direct compression diluents; and mixtures of any of the foregoing.

The excipient can include flavors. Flavors incorporated into the outer layer can be chosen from synthetic flavor oils and flavoring aromatics and/or natural oils, extracts from plants, leaves, flowers, fruits, and combinations thereof. By way of example, these can include cinnamon oils, oil of wintergreen, peppermint oils, clover oil, hay oil, anise oil, eucalyptus, vanilla, citrus oil, such as lemon oil, orange oil, grape and grapefruit oil, fruit essences including apple, peach, pear, strawberry, raspberry, cherry, plum, pineapple, and apricot.

In another aspect, the excipient can include a sweetener. By way of non-limiting example, the sweetener can be selected from glucose (corn syrup), dextrose, invert sugar, fructose, and mixtures thereof (when not used as a carrier); saccharin and its various salts such as the sodium salt; dipeptide sweeteners such as aspartame; dihydrochalcone compounds, glycyrrhizin; Stevia Rebaudiana (Stevioside); chloro derivatives of sucrose such as sucralose; sugar alcohols such as sorbitol, mannitol, sylitol, and the like.

In another aspect, the excipient can be a lubricant. Suitable non-limiting examples of lubricants include magnesium stearate, calcium stearate, zinc stearate, hydrogenated vegetable oils, sterotex, polyoxyethylene monostearate, talc, polyethyleneglycol, sodium benzoate, sodium lauryl sulfate, magnesium lauryl sulfate, and light mineral oil.

The excipient can be a dispersion enhancer. Suitable dispersants can include starch, alginic acid, polyvinylpyrrolidones, guar gum, kaolin, bentonite, purified wood cellulose, sodium starch glycolate, isoamorphous silicate, and microcrystalline cellulose as high HLB emulsifier surfactants.

Depending upon the aspect, it can be desirable to provide a coloring agent in the outer layer. Suitable color additives include food, drug and cosmetic colors (FD&C), drug and cosmetic colors (D&C), or external drug and cosmetic colors (Ext. D&C). These colors or dyes, along with their corresponding lakes, and certain natural and derived colorants, can be suitable for use in the present invention depending on the aspect.

The excipient can include a taste-masking agent. Taste-masking materials include, e.g., cellulose hydroxypropyl ethers (HPC) such as Klucel®, Nisswo HPC and PrimaFlo HP22; low-substituted hydroxypropyl ethers (L-HPC); cellulose hydroxypropyl methyl ethers (HPMC) such as Seppifilm-LC, Pharmacoat®, Metolose SR, Opadry YS, PrimaFlo, MP3295A, Benecel MP824, and Benecel MP843; methylcellulose polymers such as Methocel® and Metolose®; Ethylcelluloses (EC) and mixtures thereof such as E461, Ethocel®, Aqualon®-EC, Surelease; Polyvinyl alcohol (PVA) such as Opadry AMB; hydroxyethylcelluloses such as Natrosol®; carboxymethylcelluloses and salts of carboxymethylcelluloses (CMC) such as Aualon®-CMC; polyvinyl alcohol and polyethylene glycol co-polymers such as Kollicoat IR®; monoglycerides (Myverol), triglycerides (KLX), polyethylene glycols, modified food starch, acrylic polymers and mixtures of acrylic polymers with cellulose ethers such as Eudragit® EPO, Eudragit® RD100, and Eudragit® E100; cellulose acetate phthalate; sepifilms such as mixtures of HPMC and stearic acid, cyclodextrins, and mixtures of these materials. In other aspects, additional taste-masking materials contemplated are those described in U.S. Pat. Nos. 4,851,226; 5,075,114; and 5,876,759, each of which is hereby incorporated by reference in its entirety.

In various aspects, the excipient can include a pH modifier. In certain aspects, the pH modifier can include sodium carbonate or sodium bicarbonate.

The amount and types of ingredients (i.e., metal chelate, chondro protective agents, vitamin, mineral, amino acid, antioxidant, yeast culture, and essential fatty acid), and other excipients useful in animal feed formulation, are described throughout the specification and the examples.

### II. Feed Additive Composition

One aspect of the present disclosure encompasses feed additive compositions for non-human animals. The compositions comprise a basal animal diet supplemented with a formulated yeast and “direct fed microbial” (Yeast+DFM), in combination with L-carnitine. Other optional additives can be further included. The feed additive composition can be added to basal animal diet for administration to the non-human animals. The feed additive composition can be formulated with basal animal diets to prepare the feed compositions described in Section I.

The amount of formulated yeast in a feed additive composition can and will vary depending on the formulated yeast, the type of non-human animal that will be administered the feed additive composition comprising the formulated yeast, the body weight, sex, and medical condition of the non-human animal that will be administered the feed additive composition. Generally, a feed additive composition can comprise about 30% to about 95% formulated yeast, about 40% to about 90% formulated yeast, or about 55% to about 90% formulated yeast. In some aspects, a feed additive composition can comprise from about 88% to about 90%, or about 89%.

The amount of DFM in a feed additive composition of the instant disclosure can range from about 0.05% to about 15%, from about 0.1% to about 10%, from about 0.5% to about 5%, from about 0.9% to about 1.1%. In some aspects, the amount of DFM in a feed additive composition of the instant disclosure ranges from about 0.9% to about 1.1%.

The amount of L-carnitine in a feed additive composition of the instant disclosure 10%. about 1% to about 20%, from about 5% to about 15%, from about 7% to about 13%, from about 9% to about 11%. In some aspects, the amount of L-carnitine in a feed additive composition of the instant disclosure ranges from about 9% to about 11%.

In various aspects, a feed additive composition can be introduced to a basal animal diet by way of various methods, depending on whether the feed additive composition is in a liquid or solid form. Non-limiting examples of introducing the feed additive composition to a basal animal diet can be formulating the feed additive composition into the basal animal diet, top-dressing the solid composition of a basal animal diet, spraying a liquid feed additive composition onto a basal animal diet, or combinations thereof. It will be recognized that, when the feed additive is introduced to a basal animal diet, the amount of the feed additive introduced to a basal animal diet is sufficient to provide the therapeutically effective amount of the combination of formulated yeast and capsicum product in the diet of the animal.

In addition to yeast product, DFM, and L-carnitine, a feed additive composition can further comprise at least one additional ingredient such as vitamins, minerals, amino acids, antioxidants, probiotics other than those that may be present in DFM, essential fatty acids, and pharmaceutically acceptable excipients. Such ingredients can be as described in Section I(e) above. In some aspects, a feed additive composition further comprises rice hulls, mineral oil, and calcium stearate.

### III. Methods of Using

Another aspect of the disclosure encompasses methods of using a feed composition. The methods comprise administering the animal feed composition or the feed additive of the instant disclosure to non-human animals. In some aspects, a feed or feed additive composition is administered to non-human animals orally. A feed composition can be as described in Section (I) and a feed additive composition can be as described in Section (II) herein above.

In some aspects, the non-human animal is immunologically stressed. As used herein, the term “immunologically stressed animal” refers to a non-human animal stressed in response to inflammation, or a stressor such as a microbial infection, an induced inflammation such as due to vaccination, a psychological trauma such as weaning, and physical trauma, among other stressors. An immunologically stressed animal generally has an insufficient nutritional status as measured by insufficient circulating vitamin A. The stressors, and vitamin A insufficiency, can result in a reduced growth performance and increased mortality of the animal. Accordingly, in some aspects, a method of the instant disclosure comprises improving a nutritional status of an immunologically stressed non-human animal. In some aspects, a method of the instant disclosure comprises improving growth performance and survivability of the animal. In some aspects, a method of the instant disclosure comprises reducing inflammation in an animal.

The timing and duration of administration of a composition of the instant disclosure to an animal can and will vary. The feed composition can be administered throughout the period of feeding the animal. Alternatively, the feed composition can be administered at specific periods during the growth and development of the animal. For instance, the feed composition can be administered during periods of heightened susceptibility of the animal to infection, such as during infancy. A composition can also be administered after a microbial infection is detected and for the duration of the infection. A composition can also be administered at various intervals. For instance, a composition can be administered daily, weekly, monthly, or over a number of months. In some aspects, a composition is administered weekly. In other aspects, a composition is administered monthly. In some aspects, a composition is administered daily. As it will be recognized in the art, the duration of treatment can and will vary depending on the growth and health of the animal.

### (a) Non-Human Animals

Non-human animals, in broad term, can be defined as any animal which exhibits improved growth, improved health, improved intestinal health, and reduced microbial pathogen counts after administration of the feed additive composition. In various aspects, the non-human animal can be a livestock mammal varying in age and health. Non-limiting example of suitable livestock mammals can be beef cattle, horses, dairy cattle, veal, pigs, goats, sheep, bison, llama, or alpaca. In other aspects, the non-human animal can be an avian species varying in age and health. Non-limiting examples of suitable avian species or poultry can be chickens, including broilers, layers, and breeders, ducks, game hens, geese, pheasants, guinea fowl/hens, quail, turkeys, and ratites, such as emus and ostrich and aquaculture. In another aspect, the non-human animal can be a companion animal varying in age and health. Non-limiting examples of companion animals can be a dog, a cat, a bird, a hamster, or a Guinee pig. In some aspects, the non-human animal is selected from a group comprising growing pigs, calves, foals, kids (goats), lambs, cria, chicks, poults, ducklings, puppies, kittens, or combinations thereof. In some aspects, the non-human animal is a pig. In some aspects, the non-human animal is an immunologically stressed pig. In some aspects, the non-human animal is an immunologically stressed nursery pig.

### (b) Improved Performance

In some aspects, the methods comprise using the feed additive to improve performance of the animal. “Improved performance”, as defined herein, refers to a positive change in size and/or maturation over a period of time in the non-human animal. In various aspects, the non-human animals exhibit improved growth performance, including for example an increase in body weight gain, feed intake, average daily weight gain (ADG), a decrease in the feed conversion rate (FCR), an increase in the average daily food intake (ADFI), an improved overall body weight, and the ratio of F/G wherein the ratio of F/G is defined as the ADFI/ADG.

The non-human animals can exhibit a decrease in the feed conversion ratio ranging from about 2% to about 5%, from about 2% to about 5%, or about 3.0% or more as compared to a control group without supplementation of the feed additive composition. The non-human animals can exhibit a reduced mortality ranging from about 0.5% to about 10%, from about 1% to about 8%, from about 1% to about 5%, or at least 2.0% or more as compared to a control group without supplementation of the feed additive composition. The non-human animals can show an improved body weight gain as defined as the percent increase ranging from about 1% to about 10%, from about 3% to about 5%. Or of least 3.0% as compared to a control group without supplementation of the feed additive composition.

### (c) Improved Health

Still another aspect of the disclosure encompasses methods for improving the health of non-human animals. “Improved health”, as defined herein, refers to a reduction of incidences of diarrhea, reduction in the number of days of diarrhea, a decrease in mortality, improving intestinal health, reducing microbial pathogens in the intestinal tract of the animal, a decrease in cytokine panel measuring TNF-alpha, decrease in immunocrit levels, or combinations thereof in the non-human animals as compared to a control group.

### (d) Reduced Impact of Microbial Pathogens

Still another aspect of the disclosure encompasses methods for reducing the impact of microbial pathogens in the non-human animals. Reducing the impact of microbial pathogens can comprise improving the intestinal health and the reduction of microbial pathogens in the non-human animals. Reducing the impact of microbial pathogens can also comprise improving the general health and performance of non-human animals exposed to the microbial pathogens.

The term “microbial pathogens”, as defined herein, refers to a micro-organism that has the potential to cause disease. An infection is the invasion and multiplication of pathogenic microbes in a subject. Disease is when the infection causes damage to the subject's vital functions or systems.

“Improved intestinal health” and the “reduction of microbial pathogens” refer to a reduction in the number of pathogens and a reduction of inflammation caused by the microbial pathogens in the non-human animal as compared to a control group. Non-limiting examples of pathogenic bacteria that can be controlled using a feed additive composition of the present disclosure include Clostridium perfringens, Eimeria maxima, Aeromonas hydrophila, Yersinia enterocolitica, Vibrio spp., Leptospira spp., Mycobacterium ulcerans, Listeria spp., pathogenic strains of E. coli, Pseudomonas spp. such as aeruginosa, Enterococcus spp., Salmonella spp., Campylobacter spp., Staphylococcus spp. such as epidermidis, S. aureus (MRSA), M. smegmatis, Streptococcus sp., Clostridia, and M. marinum.

In a preferred alternative of the aspects, reducing the impact of microbial pathogens comprises reducing the impact of C. perfringens in broilers. In an alternative of the aspects, reducing the impact of microbial pathogens comprises controlling necrotic enteritis in the chicken. In another alternative, reducing the impact of microbial pathogens comprises controlling the impact of C. perfringens in combination with a coccidiosis challenge in disease-challenged broilers.

### DEFINITIONS

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there can be additional elements other than the listed elements.

As various changes could be made in the above-described cells and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Feeding a Beta-Glucan/Yeast Cell Wall/Direct Fed Microbials/L-Carnitine Combination (Combo) Increased Circulating Vitamin A Concentration, and Improved Growth Performance of Nursery Pigs After Weaning

A study was conducted to evaluate the effects of feeding a beta-glucan/yeast cell wall/direct fed microbials/L-carnitine combination. A total of 36 pens with 27 pigs per pen of mixed gender were utilized in this study. Pigs were weighed on pen basis upon arrival. Pens were blocked by weight and pens within block were randomly assigned to one of three dietary treatments in a randomized complete block design, resulting in 12 pens per treatment (Table 1).

TABLE 1
Dietary treatments

| | | Inclusion | # of | | Total # |
|---|---|---|---|---|---|
| Treatment | Additive | Rate | Pens | # pigs/pen | of pigs |
| 1. Control | None | N/A | 12 | ~27 | 323 |
| 2. Combo | beta glucan/yeast | 0.5 lb/ton | 12 | ~27 | 325 |
| | cell wall/DFM/ | | | | |
| | L-carnitine | | | | |
| 3. Yeast + | beta glucan/yeast | 0.5 lb/ton | 12 | ~27 | 324 |
| DFM | cell wall/DFM | | | | |
| | | | | TOTAL | 972 |

Analyses of Combo suggested that the concentrations of beta-glucan, total glucan and mannose were no less than 5.7%, 10.0%, and 9.0%, respectively. Concentration of DFM was no less than 7.5×10⁸ cfu/g of the product.

This experiment was conducted for 49 days in a 4-phase feeding program immediately after weaning. The composition of a commercial Control diet is shown in Table 2. Feed was provided through the FeedLogic® system allowing collection of feed intake data by pen.

Pigs were weighed on pen basis upon arrival, and by the time the majority of pens completed each phase. Feed leftover of each pen was also measured on the same days when pigs were weighed. Data from the FeedLogic® system was saved for every feeding activity. The data was used to calculate ADG, ADFI and F/G of each pen.

Blood samples were collected from 2 pigs per pen at 4 time points: two days prior to weaning at the sow unit, d 0 (immediately after weaning), 7 and 48 at the nursery unit. Serum samples were stored at −20° C. until analyses were performed. Subjective fecal score of each pen was measured on d 3, 5, and 7 at nursery using the scale of 0=none; 1=mild; 2=substantial; 3=severe signs of diarrhea.

TABLE 2
Dietary composition of Control diet (Trt 1).

| | Ph1CWG | Ph2CWG | Ph3CWG | Ph4CWG |
|---|---|---|---|---|
| | 9-15 lb | 15-22 lb | 22-37 lb | 37-52 lb |
| Ingredient Name | | | | |
| Ground Corn | 772.98 | 854.92 | 1033.37 | 977.88 |
| Distillers Dried Grain | 0.00 | 100.00 | 300.00 | 400.00 |
| SBM 46% PROTEIN | 200.00 | 445.50 | 566.72 | 512.93 |
| Milk and speciality | 950.00 | 475.00 | 0.00 | 0.00 |
| proteins | | | | |
| Blood plasma | 6.00 | 3.00 | 0.00 | 0.00 |
| CHOICE WHITE | 20.00 | 50.59 | 47.85 | 49.65 |
| GREASE | | | | |
| LYSINE 98.5% | 6.59 | 6.43 | 9.22 | 9.67 |
| METHIONINE 99% DL | 4.07 | 3.26 | 2.49 | 2.16 |
| Threonine 80% | 3.68 | 3.03 | 3.41 | 3.16 |
| TRYPTOPHAN 98.5% | 1.01 | 0.66 | 0.82 | 0.89 |
| VALINE-L AEL | 1.02 | 0.00 | 0.00 | 0.00 |
| ISOLEUCINE L | 0.34 | 0.00 | 0.00 | 0.00 |
| LIMESTONE | 0.00 | 14.36 | 18.72 | 19.66 |
| 21% MONOCAL | 13.07 | 20.07 | 5.70 | 2.10 |
| SALT | 7.00 | 10.24 | 9.00 | 9.00 |
| Optiphos 2500 | 0.00 | 0.00 | 0.66 | 0.66 |
| Vitamins & trace | 4.00 | 4.00 | 0.00 | 0.00 |
| minerals | | | | |
| Vitamins and trace | 0.00 | 0.00 | 2.00 | 2.00 |
| minerals | | | | |
| Microtracer | 0.04 | 0.04 | 0.04 | 0.04 |
| CTC 90 | 6.70 | 8.90 | 0.00 | 6.70 |
| DENAGARD 10 | 3.50 | 0.00 | 0.00 | 3.50 |
| Ingredient Total: | 2000.00 | 2000.00 | 2000.00 | 2000.00 |

Nutrient Name

| | | | | |
|---|---|---|---|---|
| Dry Matter, % | 88.77 | 88.45 | 87.76 | 87.98 |
| Mod ME, kcal/lb | 1507.93 | 1502.00 | 1500.00 | 1500.00 |
| Protein, % | 21.51 | 21.87 | 21.38 | 21.48 |
| Lysine, % | 1.56 | 1.52 | 1.47 | 1.45 |
| SID Lysine, % | 1.40 | 1.35 | 1.29 | 1.26 |
| SID Lys:ME g Lys/mcal | 4.21 | 4.08 | 3.90 | 3.81 |
| SID m + c:Lys | 0.58 | 0.58 | 0.57 | 0.57 |
| SID Thr:Lys | 0.63 | 0.63 | 0.63 | 0.63 |
| SID Tryp:Lys | 0.20 | 0.20 | 0.20 | 0.20 |
| SID Iso:Lys | 0.60 | 0.62 | 0.60 | 0.60 |
| SID Val:Lys | 0.67 | 0.67 | 0.67 | 0.68 |
| Starch, % | 31.22 | 32.21 | 36.57 | 34.83 |
| Total Sugars, % | 4.13 | 5.76 | 7.05 | 6.94 |
| Lactose, % | 15.00 | 7.50 | 0.00 | 0.00 |
| ADF, % | 1.69 | 2.56 | 3.58 | 3.78 |
| NDF, % | 4.43 | 6.43 | 9.48 | 10.43 |
| Crude Fiber, % | 1.48 | 1.98 | 2.64 | 2.86 |
| Fat, % | 4.60 | 5.52 | 5.22 | 5.59 |
| Ash, % | 6.08 | 6.43 | 4.58 | 4.55 |
| Calcium, % | 0.64 | 0.80 | 0.73 | 0.70 |
| Anzl Calcium, % | 0.63 | 0.80 | 0.55 | 0.52 |
| Non Phytase TTD Ca, % | 0.14 | 0.37 | 0.32 | 0.30 |
| Phytase TTD Ca | 0.00 | 0.00 | 0.03 | 0.03 |
| TTD Ca, % | 0.14 | 0.37 | 0.35 | 0.33 |
| Ca STTD Coeff, % | 24.46 | 35.73 | 48.17 | 48.40 |
| Phosphorus, % | 0.74 | 0.74 | 0.52 | 0.50 |
| Avail Phos Equil, % | 0.50 | 0.46 | 0.40 | 0.38 |
| Non Phytase aPhos, % | 0.50 | 0.46 | 0.22 | 0.21 |
| aP Release, % | 0.00 | 0.00 | 0.18 | 0.17 |
| P Available Coeff, % | 8.60 | 15.95 | 25.28 | 27.91 |
| Phytase, FTU/kg | 0.00 | 0.00 | 827.43 | 750.58 |
| Non Phytase TTD P, % | 0.19 | 0.29 | 0.22 | 0.21 |
| Phytase TTD P | 0.00 | 0.00 | 0.15 | 0.14 |
| TTD P, % | 0.19 | 0.29 | 0.37 | 0.35 |
| P STTD Coeff, % | 14.48 | 23.35 | 33.35 | 34.70 |
| AOAC PHYTASE, | 0.00 | 0.00 | 2068.56 | 1876.44 |
| FTU/kg | | | | |
| Phytate Phos (Est.), % | 0.24 | 0.28 | 0.30 | 0.29 |
| calcium/aP, % | 0.51 | 18.18 | 23.55 | 24.64 |
| Salt, % | 0.34 | 0.50 | 0.44 | 0.44 |
| Sodium, % | 0.40 | 0.35 | 0.22 | 0.23 |
| Cholride, % | 0.67 | 0.59 | 0.43 | 0.44 |

### Results:

### Part 1. Pre-Weaning Vaccination and Weaning Reduces Circulating Vitamin A Concentration

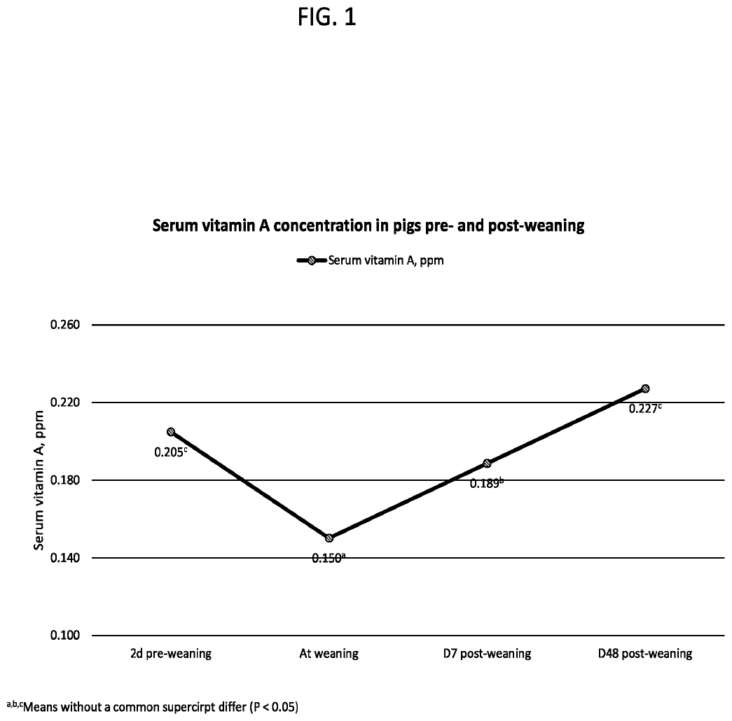

The vaccinations (PRRS/PCV2/Mycoplasma) that pigs received 2-d prior to weaning in combination with the stress from the weaning process caused 27% reduction (P<0.001) in serum vitamin A concentration on the day of weaning (FIG. 1). On d 48 post-weaning, the serum vitamin A concentration gradually restored to the similar level that was observed 2-d prior to weaning.

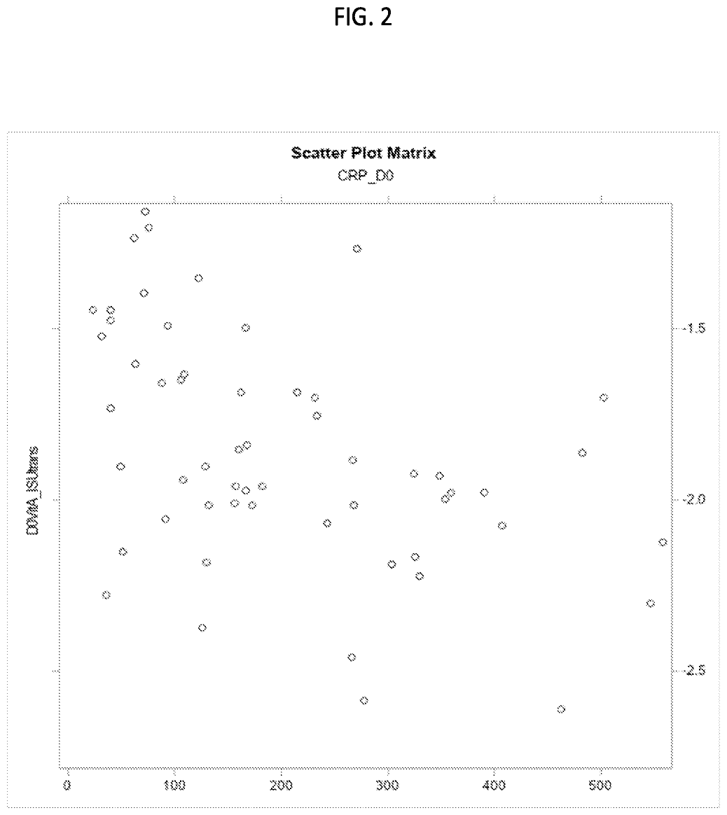

Many times, insufficient serum vitamin levels are considered to be a symptom of diet/intake deficiency. However, this is not always the case. In this example and the following examples, vitamin A was supplemented as retinyl acetate to provide 8,819.4 IU/kg of vitamin A in the diet, which was 4 times higher than the required vitamin A concentration (2,200 IU/kg) as described by National Research Council (NRC; 2012) for nursery pigs between 5 to 25 kg. The data suggests that serum vitamin A concentration at weaning inversely correlated with serum C-reactive protein (CRP), which is one of the major acute phase proteins that is elevated in serum as a result of challenge in pigs (FIG. 2).

### Part 2. Feeding a Beta-Glucan/Yeast Cell Wall/Direct Fed Microbials/L-Carnitine Combination (Combo) Restores the Circulating Vitamin A Concentration Post-Weaning

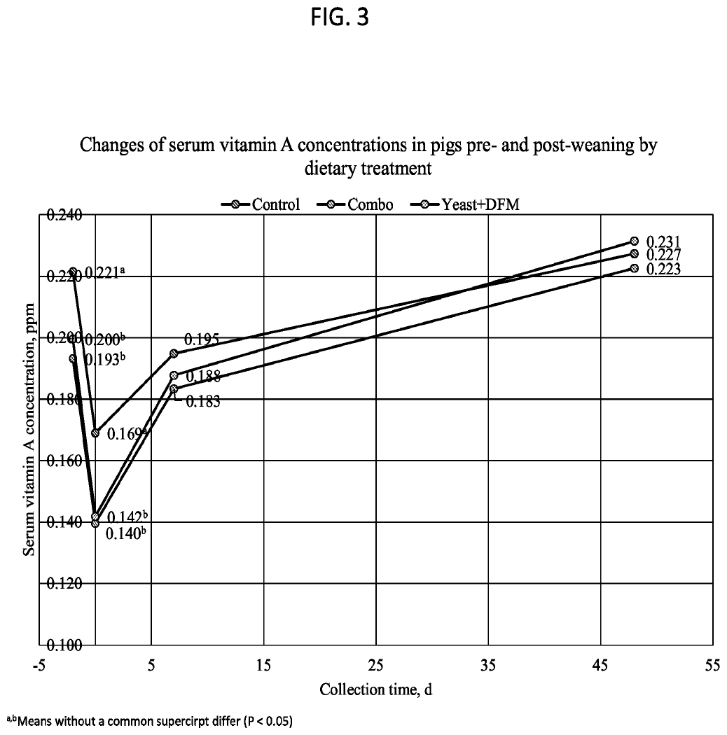

Circulating vitamin A concentration restored gradually to a similar level as was measured pre-weaning as pigs recovered from the immune stress after weaning (FIG. 3). Data from a sub-set of sampling pigs suggest that compared to the pigs fed Control and Yeast+DFM treatments, pigs fed diet containing the beta-glucan/yeast cell wall/direct fed microbials/L-carnitine combination (Combo) had the greatest increase of serum vitamin A concentration from weaning to d-7 post-weaning (38.4%) and from weaning to d-48 post-weaning (64.3%; Table 3), respectively.

The increases of serum vitamin A concentrations from weaning in pigs fed Yeast+DFM treatment were intermediate (25.8% and 60.1%, respectively). Additionally, pigs fed the Combo treatment had 20% significantly higher nursery ADG compared to pigs fed the Control diet (0.76 vs. 0.64 lb/day with P=0.01), while pigs fed Yeast+DFM treatment only marginally improved pig ADG (0.73 vs. 0.64 lb/day with P=0.10).

TABLE 3
Effects on feeding the beta-glucan/yeast cell wall/direct fed microbials/L-
carnitine combination (Combo) on serum vitamin A concentrations in pigs
pre- and post-weaning (values presented are least squares means)

| | Treatment | | | | |
|---|---|---|---|---|---|
| | | | Yeast + | | |
| Item | Control | Combo | DFM | PSE | P-value |
| Serum vitamin A and performance | | | | | |
| of all sampling pigs | | | | | |
| At sow farm | | | | | |
| # of pigs measured | 17 | 20 | 24 | | |
| Vit A 2-d pre-weaning, ppm | 0.221^{a} | 0.193^{b} | 0.200^{b} | 0.011 | 0.02 |
| At weaning (baseline) - dietary | | | | | |
| treatments started | | | | | |
| # of pigs measured | 21 | 24 | 24 | | |
| Weaning BW, lb | 10.8^{ab} | 10.6^{a} | 11.9^{b} | 0.6 | 0.04 |
| Vit A, ppm | 0.169^{a} | 0.140^{b} | 0.142^{b} | 0.014 | 0.02 |
| Vit A change pre-wean | −28.8 | −27.4 | −25.1 | 5.2 | 0.71 |
| to wean, % | | | | | |
| CRP, μg/ml | 193.8 | 177.3 | 209.6 | 42.9 | 0.75 |
| Day 7 in nursery | | | | | |
| # of pigs measured | 21 | 24 | 23 | | |
| BW on D7, lb | 11.8^{c} | 12.3^{d} | 11.7^{c} | 0.2 | 0.04 |
| ADG Day 0 to 7, lb/day | 0.06^{a} | 0.15^{b} | 0.07^{a} | 0.02 | 0.01 |
| Vit A, ppm | 0.195 | 0.183 | 0.188 | 0.011 | 0.64 |
| Vit A change wean to D7, % | 26.5 | 38.4 | 25.8 | 10.8 | 0.57 |
| CRP, μg/ml | 60.3 | 63.4 | 50.4 | 28.7 | 0.77 |
| Day 48 in nursery | | | | | |
| # of pigs measured | 20 | 21 | 24 | | |
| BW on D48, lb | 43.2^{c} | 48.1^{a} | 45.9^{cd} | 2.0 | 0.08 |
| ADG Day 7 to 48, lb/day | 0.74^{a} | 0.86^{b} | 0.84^{ab} | 0.04 | 0.02 |
| ADG Day 0 to 48, lb/day | 0.64^{a} | 0.76^{b} | 0.73^{ab} | 0.03 | 0.01 |
| Vit A, ppm | 0.227 | 0.223 | 0.231 | 0.011 | 0.87 |
| Vit A change wean to D48, % | 41.4 | 64.3 | 60.1 | 13.1 | 0.34 |
| CRP, μg/ml | 467.5^{c} | 368.3^{cd} | 329.6^{d} | 53.7 | 0.09 |

^{a, b}Means without a common superscript differ (P < 0.05)
^{c, d}Means without a common superscript tend to differ (P < 0.10)

Distribution of serum vitamin A was also evaluated. Although pigs assigned to the Combo treatment started with the lowest percentage of pigs with vitamin A sufficiency (>=0.15 ppm) prior to weaning (95%), feeding Combo in nursery resulted in highest percentage of pigs with vitamin A sufficiency at the end of the 49-d nursery phase (95.2%) compared to Control and Yeast+DFM treatment (95.0% and 91.7%, respectively, Table 4). On day 48, serum concentration of CRP in pigs fed Combo was also 21% lower than those fed Control diet (368.3 vs. 467.5 g/ml with P=0.10; Table 3). These data suggest that dietary supplementation of Combo effectively restored circulating vitamin A concentration post-weaning, which indicated greatest recovery from the immune stress caused by weaning.

TABLE 4
Distribution of serum vitamin A concentration pre- and post-weaning by dietary treatments

| Vitamin | 2-d Pre-wean | | | At weaning | | | D7 post-weaning | | | D48 post-weaning | | |
|---|---|---|---|---|---|---|---|---|---|---|---|---|
| A, | Con- | | Evosure + | | | Evosure + | | | Evosure + | | | Evosure + |
| ppm | trol | Combo | DFM | Control | Combo | DFM | Control | Combo | DFM | Control | Combo | DFM |
| <0.15 | 0.0% | 5.0% | 4.2% | 47.6% | 62.5% | 54.2% | 9.5% | 16.7% | 17.4% | 5.0% | 4.8% | 8.3% |
| 0.15-0.20 | 17.6% | 40.0% | 20.8% | 19.0% | 25.0% | 25.0% | 28.6% | 54.2% | 47.8% | 15.0% | 28.6% | 16.7% |
| 0.20-0.25 | 41.2% | 30.0% | 50.0% | 14.3% | 12.5% | 16.7% | 42.9% | 16.7% | 21.7% | 40.0% | 52.4% | 50.0% |
| 0.25-0.30 | 35.3% | 25.0% | 20.8% | 19.0% | 0.0% | 0.0% | 19.0% | 4.2% | 8.7% | 30.0% | 9.5% | 25.0% |
| >0.30 | 5.9% | 0.0% | 4.2% | 0.0% | 0.0% | 4.2% | 0.0% | 8.3% | 4.3% | 10.0% | 4.8% | 0.0% |
| Insufficient* | 0.0% | 5.0% | 4.2% | 47.6% | 62.5% | 54.2% | 9.5% | 16.7% | 17.4% | 5.0% | 4.8% | 8.3% |
| Sufficient* | 100.0% | 95.0% | 95.8% | 52.4% | 37.5% | 45.8% | 90.5% | 83.3% | 82.6% | 95.0% | 95.2% | 91.7% |

*Vitamin A insuficient was defined as serum vitamin A concentration <0.15 ppm, while vitamin A sufficient was defined as serum vitamin A concentration >=0.15 ppm according to the reference from R. Puls, 1994.

### Part 3. Correlation Between Circulating Vitamin A Concentration and Pig Growth Performance

Linear correlation analysis was performed to evaluate the correlation between serum vitamin A concentrations measured at pre- and post-weaning and the individual pig growth performance during nursery period (ADG and BW). Among the 24 pairs of correlation analysis, either numerically or significantly positive correlation was determined (Table 5). Particularly, serum vitamin A at weaning was positively correlated with pig ADG and BW throughout the entire nursery period. Pig BW at the end of the nursery period was positively correlated with serum vitamin A of pre- and post-weaning (P<0.052). The abundance of positive correlations between serum vitamin A and pig ADG/BW suggests that circulating vitamin A could be performance-indicating.

TABLE 5
Correlation between serum vitamin A concentration
and pig growth performance
Pearson Correlation Coefficients
Prob > |r| under H0: Rho = 0
Number of Observations

| | PreWean_VitA | VitA_Wean | VitA_D7 | VitA_D48 |
|---|---|---|---|---|
| ADG Wean | −0.03499 | 0.19918 | 0.26808 | 0.02914 |
| to D7 | | | | |
| P-value | 0.7889 | 0.1034 | 0.0271 | 0.8178 |
| | 61 | 68 | 68 | 65 |
| ADG | 0.19241 | 0.37513 | 0.20262 | 0.35489 |
| D7 to D48 | | | | |
| P-value | 0.1443 | 0.0021 | 0.1055 | 0.0037 |
| | 59 | 65 | 65 | 65 |
| ADG Wean | 0.18126 | 0.38770 | 0.23397 | 0.33414 |
| to D48 | | | | |
| P-value | 0.1695 | 0.0014 | 0.0607 | 0.0065 |
| | 59 | 65 | 65 | 65 |
| BW_wean | 0.43674 | 0.45798 | 0.12447 | 0.01392 |
| P-value | 0.0004 | <.0001 | 0.3118 | 0.9124 |
| | 61 | 69 | 68 | 65 |
| BW_D7 | 0.40425 | 0.49872 | 0.21158 | 0.02329 |
| P-value | 0.0012 | <.0001 | 0.0833 | 0.8539 |
| | 61 | 68 | 68 | 65 |
| BW_D48 | 0.25467 | 0.50016 | 0.28635 | 0.26421 |
| P-value | 0.0516 | <.0001 | 0.0207 | 0.0334 |
| | 59 | 65 | 65 | 65 |

### Part 4. Feeding a Beta-Glucan/Yeast Cell Wall/Direct Fed Microbials/L-Carnitine Combination (Combo) Improved Growth Performance and Survivability of Nursery Pigs After Weaning

As shown in Table 6, when the performance data of all pigs were analyzed, feeding a nursery diet containing Combo resulted in significantly higher pig ADG and BW at the end of the 49-d nursery period compared to pigs fed the Control diet (0.69 vs. 0.65 lb/day with P<0.05, 45.5 vs. 43.4 lb with P<0.05, respectively). Pigs fed Yeast+DFM had an intermediate ADG and BW which were not significantly different than pigs fed Control treatment. Additionally, feeding Combo and Yeast+DFM showed lower mortality rates compared to feeding the Control treatment (1.85 vs. 3.41%). Pigs fed Combo also tended to require less individual antibiotic treatment compared to those fed Control diet (6.5 vs. 10.5% with P<0.10). These results suggest that feeding Combo improved pig growth performance and survivability post-weaning.

TABLE 6
Effects of feeding a beta-glucan/yeast cell wall/direct
fed microbials/L-carnitine combination (Combo)
on growth performance of nursery pigs

| | Treatment | | | | |
|---|---|---|---|---|---|
| | | | Yeast + | | |
| Item | Control | Combo | DFM | PSE | P-value |
| # of Pens | 12 | 12 | 12 | | |
| # of Pigs | 323 | 325 | 324 | | |
| Wean age, d | | | | | |
| Start BW, lb | 10.9 | 10.9 | 10.9 | 0.3 | 0.98 |
| Early nursery; Phase | | | | | |
| 1 to 2; 21 d | | | | | |
| ADG, lb/day | 0.36^{a} | 0.39^{b} | 0.37^{ab} | 0.01 | 0.03 |
| ADFI, lb/day | 0.70 | 0.70 | 0.68 | 0.02 | 0.17 |
| F/G | 1.99^{a} | 1.84^{b} | 1.87^{ab} | 0.04 | 0.009 |
| BW end of | 18.5^{a} | 19.2^{b} | 18.7^{ab} | 0.2 | 0.04 |
| Phase 2, lb | | | | | |
| Mortality, % | 1.24 | 1.23 | 0.93 | N/A | 0.91 |
| Fallback, % | 0.93^{ab} | 1.23^{b} | 0.00^{a} | N/A | 0.16 |
| Removal, % | 2.17 | 2.46 | 0.93 | N/A | 0.31 |
| Antibiotic-treated | 10.2^{a} | 5.8^{b} | 5.6^{b} | N/A | 0.05 |
| pigs, % | | | | | |
| Closeout ADG, | 0.35^{a} | 0.37^{b} | 0.36^{ab} | 0.01 | 0.07 |
| lb/day | | | | | |
| Closeout F/G | 2.02^{a} | 1.86^{b} | 1.87^{ab} | 0.06 | 0.02 |
| Late nursery; Phase | | | | | |
| 3 to 4; 28 d | | | | | |
| ADG, lb/day | 0.87 | 0.93 | 0.91 | 0.02 | 0.13 |
| ADFI, lb/day | 1.32^{a} | 1.43^{b} | 1.37^{ab} | 0.03 | 0.03 |
| F/G | 1.52 | 1.53 | 1.51 | 0.02 | 0.50 |
| BW end of Phase | 43.4^{a} | 45.5^{b} | 44.3^{ab} | 0.5 | 0.02 |
| 4, lb | | | | | |
| Mortality, % | 2.17^{c} | 0.62^{d} | 0.93^{cd} | N/A | 0.17 |
| Fallback, % | 0.93 | 1.54 | 0.31 | N/A | 0.27 |
| Removal, % | 3.10 | 2.15 | 1.23 | N/A | 0.27 |
| Antibiotic-treated | 0.3^{a} | 0.6^{ab} | 2.2b | N/A | 0.05 |
| pigs, % | | | | | |
| Closeout ADG, | 0.85 | 0.92 | 0.90 | 0.02 | 0.13 |
| lb/day | | | | | |
| Closeout F/G | 1.56 | 1.55 | 1.52 | 0.02 | 0.39 |
| Overall; Phase 1 to | | | | | |
| 4; 49 d | | | | | |
| ADG, lb/day | 0.65^{a} | 0.69^{b} | 0.67^{ab} | 0.01 | 0.03 |
| ADFI, lb/day | 1.05^{c} | 1.11^{d} | 1.08^{cd} | 0.02 | 0.08 |
| F/G | 1.63^{a} | 1.60^{ab} | 1.58^{b} | 0.01 | 0.05 |
| Mortality, % | 3.41 | 1.85 | 1.85 | N/A | 0.33 |
| Fallback, % | 1.86^{a} | 2.77^{a} | 0.31^{b} | N/A | 0.05 |
| Removal, % | 5.26^{b} | 4.62^{b} | 2.16 | N/A | 0.12 |
| Antibiotic-treated | 10.5^{c} | 6.5^{d} | 7.70 | N/A | 0.18 |
| pigs, % | | | | | |
| Closeout ADG, | 0.63^{a} | 0.68^{b} | 0.67^{ab} | 0.01 | 0.04 |
| lb/day | | | | | |
| Closeout F/G | 1.67^{a} | 1.63^{ab} | 1.60^{b} | 0.02 | 0.05 |
| Fecal score | | | | | |
| D3 | 0.17 | 0.08 | 0.17 | 0.11 | 0.61 |
| D5 | 0.58 | 0.58 | 0.67 | 0.21 | 0.86 |
| D7 | 0.58^{a} | 0.67^{ab} | 1.00^{b} | 0.21 | 0.04 |
| Average | 0.44 | 0.44 | 0.61 | 0.15 | 0.27 |

^{a, b}Means without a common superscript differ (P < 0.05)
^{c, d}Means without a common superscript tend to differ (P < 0.10)

### Example 2. Feeding a Beta-Glucan/Yeast Cell Wall/Direct Fed Microbials/L-Carnitine Combination (Combo) Improved Feed Efficiency of Growing Pigs

A 11-week study was conducted to evaluate the effects of feeding Combo and Yeast+DFM to a group of immunologically stressed growing pigs on growth performance and survivability. This group of immunologically stressed pigs were characterized as PRRS and SIV positive with relatively higher mortality and morbidity rate than their production standards. At arrival, pigs (˜35 lb) were sorted into pens with 17-26 pigs per pen and balanced as closely as possible on gender. Pigs were fed a common diet until the start of the trial, approximately 2 to 3 weeks later. On the first day of the experiment, pens were weighed and blocked by average BW, and pens within block were randomly assigned to one of 3 dietary treatments (Table 7) in a randomized complete block design. This resulted in 11 pens per treatment for the evaluation of growth performance and health status.

TABLE 7
Dietary treatments

| | | Inclusion | # of | | Total # |
|---|---|---|---|---|---|
| Treatment | Additive | Rate | Pens | # pigs/pen | of pigs |
| 1. Control | None | N/A | 11 | 17-26 | 235 |
| 2. Combo | beta glucan/yeast | 0.5 lb/ton | 11 | 17-26 | 243 |
| | cell wall/DFM/ | | | | |
| | L-carnitine | | | | |
| 3. Yeast + | beta glucan/yeast | 0.5 lb/ton | 11 | 17-26 | 223 |
| DFM | cell wall/DFM | | | | |
| | | | | TOTAL | 701 |

Pigs were weighed by pen every 2 weeks (+/−1 day) except between barn top and run out. Feed leftover was measured at the time each pen was weighed. This allowed for the calculation of ADG, ADFI, and F/G by pen. The composition of the basal diet is shown in Table 8.

Blood samples were collected prior to the start of the trial as a baseline measurement from two average-sized barrows per pen. These sampling pigs were tagged for subsequent bleedings on Day 32 and 76 after the trial initiated. Serum samples were stored at −20° C. until vitamin A analyses were performed.

TABLE 8
Dietary composition of Control diet (Trt 1).

| | 55-75 | 75-95 | 95-135 | 135-165 | 165-190 | 190-215 |
|---|---|---|---|---|---|---|
| Ingredient Name | CWG | CWG | CWG | CWG | CWG | CWG |
| Ground corn | 896.65 | 958.98 | 1025.79 | 1096.13 | 1140.99 | 1183.52 |
| Dried distillers grains | 600.00 | 600.00 | 600.00 | 600.00 | 600.00 | 600.00 |
| SBM 46% PROTEIN | 376.90 | 313.30 | 240.80 | 177.12 | 133.61 | 97.40 |
| CHOICE WHITE GREASE | 75.34 | 75.92 | 76.31 | 77.52 | 75.67 | 74.74 |
| LIPINATE | 0.00 | 0.00 | 0.00 | 0.00 | 0.00 | 0.00 |
| LYSINE 98.5% | 10.39 | 10.10 | 9.79 | 9.51 | 9.33 | 9.17 |
| METHIONINE 99% DL | 1.33 | 0.89 | 0.57 | 0.00 | 0.00 | 0.00 |
| Threonine 80% | 2.21 | 1.92 | 1.83 | 1.51 | 1.30 | 1.32 |
| TRYPTOPHAN 98.5% | 0.56 | 0.59 | 0.63 | 0.66 | 0.69 | 0.71 |
| LIMESTONE | 23.79 | 25.47 | 23.65 | 24.82 | 22.18 | 20.50 |
| SALT | 10.00 | 10.00 | 10.00 | 10.00 | 10.00 | 10.00 |
| INTELLIBOND C (TBCC) | 0.49 | 0.49 | 0.49 | 0.49 | 0.49 | 0.50 |
| Optiphos 2500 | 0.30 | 0.30 | 0.30 | 0.30 | 0.30 | 0.30 |
| Vitamin & trace mineral premix | 2.00 | 2.00 | 1.90 | 1.90 | 1.90 | 1.80 |
| Aureomycin 90 | 0.00 | 0.00 | 4.40 | 0.00 | 0.00 | 0.00 |
| Denagard 10 | 0.00 | 0.00 | 3.50 | 0.00 | 3.50 | 0.00 |
| microtracer | 0.04 | 0.04 | 0.04 | 0.04 | 0.04 | 0.04 |
| Ingredient Total: | 2000.00 | 2000.00 | 2000.00 | 2000.00 | 2000.00 | 2000.00 |
| Nutrient composition | | | | | | |
| Dry Matter, % | 88.57 | 88.50 | 88.39 | 88.32 | 88.23 | 88.17 |
| Mod ME, kcal/lb | 1519.00 | 1521.00 | 1526.00 | 1529.00 | 1531.00 | 1533.00 |
| Protein, % | 21.00 | 19.70 | 18.24 | 16.94 | 16.07 | 15.36 |
| Lysine, % | 1.36 | 1.26 | 1.15 | 1.06 | 0.99 | 0.94 |
| SID Lysine, % | 1.16 | 1.07 | 0.97 | 0.88 | 0.82 | 0.77 |
| SID Lys: ME g Lys/mcal | 3.45 | 3.18 | 2.87 | 2.60 | 2.42 | 2.27 |
| SID m + c: Lys | 0.57 | 0.57 | 0.58 | 0.57 | 0.59 | 0.61 |
| SID Thr: Lys | 0.62 | 0.62 | 0.63 | 0.63 | 0.63 | 0.64 |
| SID Tryp: Lys | 0.18 | 0.18 | 0.18 | 0.18 | 0.18 | 0.18 |
| SID Iso: Lys | 0.60 | 0.60 | 0.60 | 0.60 | 0.60 | 0.60 |
| SID Val: Lys | 0.71 | 0.72 | 0.73 | 0.75 | 0.76 | 0.77 |
| Starch, % | 31.32 | 33.45 | 36.00 | 38.13 | 39.78 | 41.11 |
| Total Sugars, % | 6.53 | 6.19 | 5.81 | 5.47 | 5.25 | 5.06 |
| ADF, % | 4.12 | 4.00 | 3.87 | 3.75 | 3.67 | 3.61 |
| NDF, % | 12.21 | 12.10 | 11.98 | 11.87 | 11.81 | 11.75 |
| Crude Fiber, % | 3.23 | 3.15 | 3.06 | 2.97 | 2.92 | 2.87 |
| Fat, % | 7.39 | 7.46 | 7.53 | 7.63 | 7.58 | 7.56 |
| IV, meq/kg f | 109.73 | 110.47 | 111.53 | 112.29 | 113.08 | 113.69 |
| IVP, actual | 65.05 | 65.89 | 66.83 | 67.89 | 67.81 | 67.93 |
| Ash, % | 4.81 | 4.73 | 4.45 | 4.34 | 4.09 | 3.92 |
| Anzl Calcium, % | 0.56 | 0.58 | 0.53 | 0.54 | 0.48 | 0.44 |
| Non Phytase TTD Ca, % | 0.32 | 0.34 | 0.31 | 0.32 | 0.28 | 0.26 |
| Phytase TTD Ca | 0.03 | 0.03 | 0.03 | 0.03 | 0.03 | 0.03 |
| TTD Ca, % | 0.35 | 0.37 | 0.34 | 0.35 | 0.31 | 0.29 |
| Ca STTD Coeff, % | 48.49 | 48.60 | 48.71 | 48.81 | 48.92 | 48.99 |
| Avail Phos Equil, % | 0.37 | 0.36 | 0.36 | 0.36 | 0.35 | 0.35 |
| Non Phytase aPhos, % | 0.23 | 0.23 | 0.23 | 0.22 | 0.22 | 0.22 |
| aP Release, % | 0.13 | 0.13 | 0.13 | 0.13 | 0.13 | 0.13 |
| P Available Coeff, % | 33.11 | 32.82 | 32.51 | 32.21 | 32.05 | 31.91 |
| Phytase, FTU/kg | 375.00 | 375.00 | 375.00 | 375.00 | 375.00 | 375.00 |
| Non Phytase TTD P, % | 0.22 | 0.22 | 0.21 | 0.21 | 0.20 | 0.20 |
| Phytase TTD P | 0.11 | 0.11 | 0.11 | 0.11 | 0.11 | 0.11 |
| TTD P, % | 0.33 | 0.33 | 0.32 | 0.32 | 0.31 | 0.31 |
| P STTD Coeff, % | 37.25 | 37.17 | 36.98 | 36.89 | 36.76 | 36.66 |
| AOAC PHYTASE, FTU/kg | 937.50 | 937.50 | 937.50 | 937.50 | 937.50 | 937.50 |
| Phytate Phos (Est.), % | 0.27 | 0.26 | 0.24 | 0.23 | 0.23 | 0.22 |
| calcium/aP, % | 29.53 | 31.53 | 29.25 | 30.62 | 27.38 | 25.31 |
| Salt, % | 0.49 | 0.49 | 0.49 | 0.49 | 0.49 | 0.49 |
| Sodium, % | 0.26 | 0.26 | 0.26 | 0.26 | 0.26 | 0.26 |
| Cholride, % | 0.48 | 0.48 | 0.48 | 0.47 | 0.47 | 0.47 |

### Results:

### Part 1. Feeding a Beta-Glucan/Yeast Cell Wall/Direct Fed Microbials/L-Carnitine Combination (Combo) Improved Feed Efficiency and Survivability of Immunologically Stressed Growing Pigs

Results from Table 9 showed that pigs fed Combo had 5-point reduction in closeout F/G compared to those fed Control (2.22 vs. 2.27 with P=0.28). However, pigs fed Yeast+DFM did not show any effect on feed efficiency. Additionally, feeding Combo tended to reduce mortality rate (0.82 vs. 2.98% with P=0.09) and significantly reduced total removal rate of health-compromised pigs (2.47 vs. 2.98% with P=0.04) compared to feeding Control diet. These results suggest that feeding Combo improved feed efficiency and survivability of immunologically stressed growing pigs.

TABLE 9
Effects of feeding a beta-glucan/yeast cell wall/direct
fed microbials/L-carnitine combination (Combo) on growth
performance of immunologically stressed growing pigs

| | | | Yeast + | | |
|---|---|---|---|---|---|
| Item | Control | Combo | DFM | PSE | P-value |
| # of Pens | 11 | 11 | 11 | | |
| # of Pigs | 235 | 243 | 223 | | |
| Start BW, lb | 61.5 | 61.8 | 62.0 | 1.2 | 0.59 |
| ADG, lb/day | 1.93 | 1.92 | 1.93 | 0.02 | 0.77 |
| ADFI, lb/day | 4.22 | 4.23 | 4.31 | 0.05 | 0.40 |
| Closeout F/G | 2.27 | 2.22 | 2.28 | 0.03 | 0.35 |
| BW end of Wk 11, lb | 213.4 | 210.7 | 212.3 | 1.5 | 0.44 |
| Mortality, % | 2.98^{c} | 0.82^{d} | 0.90^{cd} | N/A | 0.11 |
| Total removal, % | 6.38^{a} | 2.47^{b} | 4.04^{ab} | N/A | 0.12 |

^{a, b}Means without a common superscript differ (P < 0.05)
^{c, d}Means without a common superscript tend to differ (P < 0.10)

### Part 2. Feeding a Beta-Glucan/Yeast Cell Wall/Direct Fed Microbials/L-Carnitine Combination (Combo) Improved Circulation Vitamin A Concentration Which Correlates With Better Pig Performance

Serum vitamin A concentrations were evaluated in 22 sampling pigs per treatment on Day 0 (baseline), 32 and 76 of the experiment (Table 10). Feeding Combo numerically improved serum vitamin A concentration by 0.9% and 4.1% on D32 and D76, respectively, compared to Control. However, feeding Yeast+DFM had either none or intermediate improvement.

TABLE 10
Effects of feeding a beta-glucan/yeast cell wall/direct fed
microbials/L-carnitine combination (Combo) on serum vitamin
A concentration of immunologically stressed growing pigs

| Serum vitamin A | | | Yeast + | | |
|---|---|---|---|---|---|
| concentration, ppm | Control | Combo | DFM | PSE | P-value |
| # of samples | 22 | 22 | 22 | | |
| Serum vitamin A - D0 | 0.180 | 0.186 | 0.188 | 0.008 | 0.77 |
| (Baseline)¹ | | | | | |
| Serum vitamin A - D32 | 0.191 | 0.193 | 0.191 | 0.010 | 0.98 |
| Serum vitamin A - D76 | 0.197 | 0.205 | 0.202 | 0.009 | 0.78 |

¹Baseline vitamin A concentration was used as covariate for analyses of vitamin A concentrations on D32 and 76

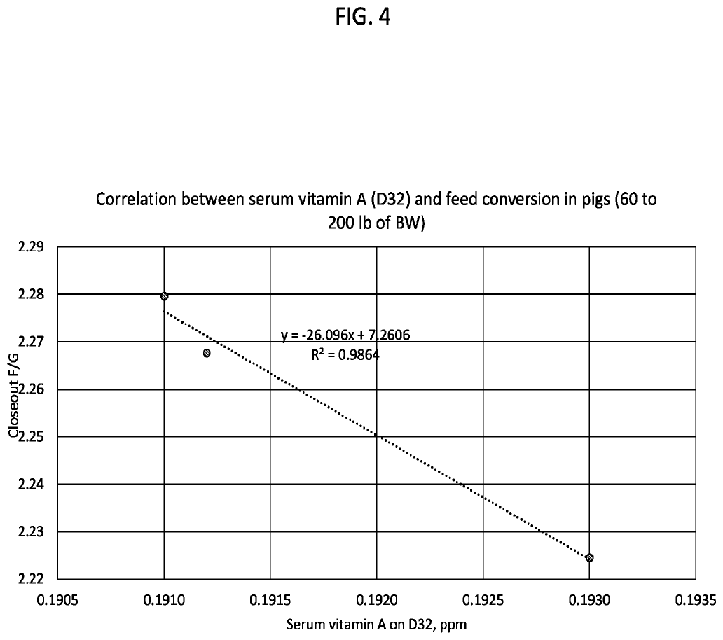

General linear model was performed using the means of closeout F/G, total removal rate and serum vitamin A from each treatment. Serum vitamin A on D32 was inversely correlated with pig F/G and could be used to predict pig F/G using the equation (FIG. 4):

$$F / G ( 60 to 200 lb of BW ) = - 26.0 \; 96 \times serum vitamin A ( D 32 ) + 7.2606 ,$$

$$with$$

$$R 2 = 0. 99$$

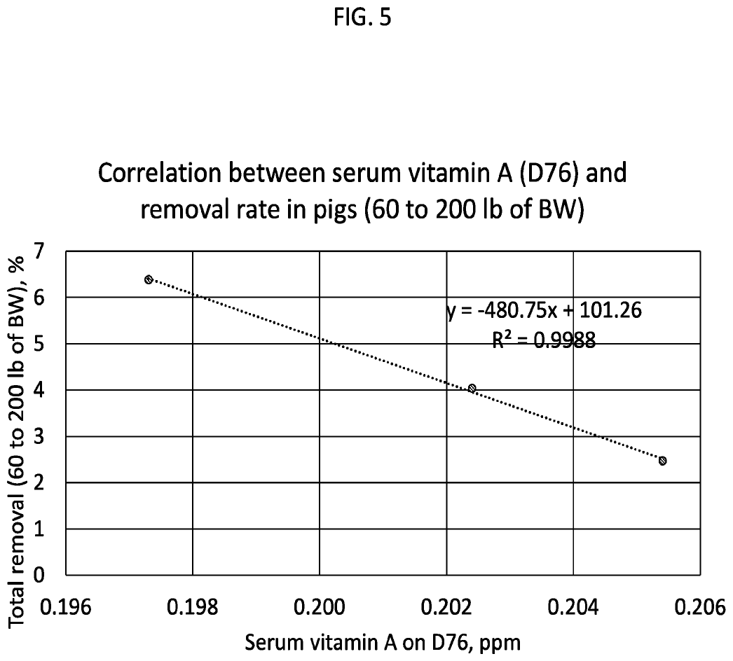

Serum vitamin A on D76 was negatively correlated with removal rate and could be used to predict pig total removal rate using the equation (FIG. 5):

$$Total removal rate ( \% ) = - 4 80.75 \times serum vitamin A ( D 76 ) + 101.26 ,$$

$$with$$

$$R 2 = 1.$$

The strong linear correlation and predictability of serum vitamin A between pig F/G and removal rate suggested that serum vitamin A could be performance-indicating in immunologically stressed growing pigs. Feeding Combo improved feed conversion, nutritional status, and health status of immunologically stressed pigs.

### Example 3. Dose Responses of Feeding a Beta-Glucan/Yeast Cell Wall/Direct Fed Microbials/L-Carnitine Combination (Combo) to Nursery and Growing Pigs

To evaluate the dose responses of feeding Combo to nursery pigs, high (1.0 lb/ton) and low (0.5 lb/ton) dietary concentrations of Combo were fed to weanling pigs in the study that was described in Example 1. For relatively healthier nursery pigs without major health issues, feeding Combo at the lower dose of 0.5 lb/ton resulted in better growth performance (Table 11) and greater increase of serum vitamin A post-weaning (Table 12) compared to feeding Combo at the higher dose of 1.0 lb/ton. Feeding Combo at the higher dose showed intermediate improvement compared with feeding Control treatment.

To evaluate the dose responses of feeding Combo to growing pigs, high (1.0 lb/ton) and low (0.5 lb/ton) dietary concentrations of Combo were fed to growing pigs in the study that was described in Example 2. Feeding Combo at the lower dose of 0.5 lb/ton resulted in better feed efficiency and survivability compared to feeding Combo at the higher dose of 1.0 lb/ton (Table 13) in immunologically stressed growing pigs. The dose responses of feeding Combo in nursery and growing pigs can depend on health and immune status of the pigs.

TABLE 11
Effects of feeding high (1.0 lb/ton) and low [0.5 lb/ton) dietary concentrations
of beta-glucan/yeast cell wall/direct fed microbials/L-carnitine
combination (Combo) on growth performance of nursery pigs

| | Treatment | | | | | Combo_1.0 | Combo_0.5 |
|---|---|---|---|---|---|---|---|
| Item | Control | Combo_1.0 | Combo_0.5 | PSE | P-value | vs. CON | vs. CON |
| # of Pens | 12 | 12 | 12 | | | | |
| # of Pigs | 323 | 324 | 325 | | | | |
| Wean age, d | | | | | | | |
| Start BW, lb | 10.9 | 10.9 | 10.9 | 0.3 | 1.00 | | |
| Early nursery; Phase 1 to 2; | | | | | | | |
| 21 d | | | | | | | |
| ADG, lb/day | 0.36 | 0.37 | 0.39 | 0.01 | 0.14 | 3% | 8% |
| ADFI, lb/day | 0.70 | 0.69 | 0.70 | 0.02 | 0.43 | −1% | −1% |
| F/G | 1.99ª | 1.91^{ab} | 1.84^{b} | 0.04 | 0.05 | −4% | −8% |
| BW end of Phase 2, lb | 18.5 | 18.7 | 19.2 | 0.2 | 0.15 | 1% | 3% |
| Mortality, % | 1.24 | 0.31 | 1.23 | N/A | 0.57 | | |
| Fallback, % | 0.93 | 1.23 | 1.23 | N/A | 0.27 | | |
| Total removal, % | 2.17 | 1.54 | 2.46 | N/A | 0.47 | | |
| Treated pigs, % | 10.2ª | 6.5^{ab} | 5.8^{b} | N/A | 0.09 | | |
| Closeout ADG, lb/day | 0.35 | 0.36 | 0.37 | 0.01 | 0.24 | 4% | 8% |
| Closeout F/G | 2.02^{c} | 1.93^{cd} | 1.86^{d} | 0.06 | 0.08 | −5% | −8% |
| Late nursery; Phase 3 to 4; | | | | | | | |
| 28 d | | | | | | | |
| ADG, lb/day | 0.87 | 0.92 | 0.93 | 0.02 | 0.17 | 5% | 7% |
| ADFI, lb/day | 1.32^{c} | 1.39^{cd} | 1.43^{d} | 0.03 | 0.07 | 5% | 8% |
| F/G | 1.52 | 1.52 | 1.53 | 0.02 | 0.78 | 0% | 1% |
| BW end of Phase 4, lb | 43.4ª | 44.6ª^{b} | 45.5^{b} | 0.5 | 0.04 | 3% | 5% |
| Mortality, % | 2.17^{c} | 1.54^{cd} | 0.62^{d} | N/A | 0.32 | | |
| Falback, % | 0.93 | 0.31 | 1.54 | N/A | 0.22 | | |
| Total removal, % | 3.10 | 1.85 | 2.15 | N/A | 0.42 | | |
| Treated pigs, % | 0.3ª | 2.2^{b} | 0.6^{ab} | N/A | 0.06 | | |
| Closeout ADG, lb/day | 0.85 | 0.90 | 0.92 | 0.02 | 0.16 | 6% | 8% |
| Closeout F/G | 1.56 | 1.54 | 1.55 | 0.02 | 0.49 | −1% | −1% |
| Overall; Phase 1 to 4; 49 d | | | | | | | |
| ADG, lb/day | 0.65ª | 0.68^{ab} | 0.69^{b} | 0.01 | 0.03 | 5% | 7% |
| ADFI, lb/day | 1.05 | 1.09 | 1.11 | 0.02 | 0.19 | 3% | 5% |
| F/G | 1.63 | 1.60 | 1.60 | 0.02 | 0.49 | −1% | −2% |
| Mortality, % | 3.41 | 1.85 | 1.85 | N/A | 0.45 | | |
| Fallback, % | 1.86 | 1.54 | 2.77 | N/A | 0.10 | | |
| Total removal, % | 5.26 | 3.40 | 4.62 | N/A | 0.19 | | |
| Treated pigs, % | 10.5^{c} | 8.6^{cd} | 6.5^{d} | N/A | 0.33 | | |
| Closeout ADG, lb/day | 0.63^{a} | 0.67ª^{b} | 0.68^{b} | 0.01 | 0.05 | 6% | 8% |
| Closeout F/G | 1.67ª | 1.63^{b} | 1.63^{b} | 0.02 | 0.05 | −2% | −3% |
| Fecal score | | | | | | | |
| D3 | 0.17 | 0.17 | 0.08 | 0.11 | 0.88 | | |
| D5 | 0.58 | 0.67 | 0.58 | 0.21 | 0.93 | | |
| D7 | 0.58^{c} | 0.83^{cd} | 0.67^{cd} | 0.21 | 0.06 | | |
| Average | 0.44 | 0.56 | 0.44 | 0.15 | 0.40 | | |

^{a,b}Means without a common superscript difer (P < 0.05)
^{c,d}Means without a common superscript tend to difer (P < 0.10)

TABLE 12
Effects of feeding high (1.0 lb/ton) and low (0.5 lb/ton) dietary concentrations of a beta-glucan/yeast
cell wall/direct fed microbials/L-carnitine combination (Combo) on serum vitamin A
concentrations in pigs pre- and post-weaning (values presented are least squares means)

| | Treatment | | | | | Combo_1.0 | Combo_0.5 |
|---|---|---|---|---|---|---|---|
| Item | Control | Combo_1.0 | Combo_0.5 | PSE | P-value | vs. CON | vs. CON |
| At sow farm | | | | | | | |
| # of pigs measured | 17 | 18 | 20 | | | | |
| Vit A 2-d pre-weaning, | 0.221 | 0.200 | 0.193 | −10% | 0.17 | −10% | −13% |
| ppm | | | | | | | |
| At weaning in nursery (baseline)- | | | | | | | |
| dietary treatments started | | | | | | | |
| # of pigs measured | 21 | 22 | 24 | | | | |
| Weaning BW, lb | 10.8^{ab} | 11.1^{b} | 10.6ª | 0.6 | 0.04 | 3% | −1% |
| Vit A, ppm | 0.169^{c} | 0.161^{cd} | 0.140^{d} | 0.014 | 0.04 | −5% | −17% |
| Vit A change pre-wean to | −0.052 | −0.039 | −0.054 | 0.012 | 0.21 | −26% | 2% |
| wean, ppm | | | | | | | |
| Vit A change pre-wean to | −28.8 | −17.1 | −27.4 | 5.2 | 0.17 | −41% | −5% |
| wean, % | | | | | | | |
| Day 7 in nursery | | | | | | | |
| # of pigs measured | 21 | 22 | 24 | | | | |
| BW on D7, lb | 11.8^{c} | 12.0^{cd} | 12.3^{d} | 0.2 | 0.05 | 2% | 5% |
| BW change wean to D7, lb | 0.55^{c} | 0.82^{cd} | 1.12^{d} | 0.18 | 0.05 | 50% | 104% |
| ADG Day 0 to 7, lb/day | 0.06ª | 0.10^{ab} | 0.15^{b} | 0.02 | 0.02 | 78% | 164% |
| Vit A, ppm | 0.195 | 0.199 | 0.183 | 0.011 | 0.60 | 2% | −6% |
| Vit A change wean to D7, | 0.026 | 0.038 | 0.044 | 0.012 | 0.93 | 46% | 69% |
| ppm | | | | | | | |
| Vit A change wean to | 26.5 | 26.4 | 38.4 | 10.8 | 0.71 | 0% | 45% |
| D7, % | | | | | | | |
| Day 48 in nursery | | | | | | | |
| # of pigs measured | 20 | 19 | 21 | | | | |
| BW on D48, lb | 43.2 | 45.0 | 48.1 | 2.0 | 0.17 | 4% | 11% |
| BW change D7 to D48, lb | 31.5 | 33.0 | 35.6 | 1.9 | 0.24 | 5% | 13% |
| BW change wean to D48, | 31.9 | 33.7 | 36.8 | 2.0 | 0.17 | 6% | 15% |
| lb | | | | | | | |
| ADG day 7 to 48, lb/day | 0.74^{c} | 0.79^{cd} | 0.86^{d} | 0.04 | 0.08 | 8% | 17% |
| ADG Day 0 to 48, lb/day | 0.64ª | 0.69^{ab} | 0.76^{b} | 0.03 | 0.05 | 9% | 20% |
| Vit A, ppm | 0.227 | 0.222 | 0.223 | 0.011 | 0.89 | −2% | −2% |
| Vit A change wean to D48, | 0.058 | 0.061 | 0.083 | 0.016 | 0.49 | 5% | 42% |
| ppm | | | | | | | |
| Vit A change wean to | 41.4 | 40.6 | 64.3 | 13.1 | 0.27 | −2% | 55% |
| D48, % | | | | | | | |

^{a,b}Means without a common superscript differ (P < 0.05)
^{c,d}Means without a common superscript tend to differ (P < 0.10)

TABLE 13
Effects of feeding high (1.0 lb/ton) and low (0.5 lb/ton)
dietary concentrations of a beta-glucan/yeast cell wall/direct
fed microbials/L-carnitine combination (Combo) on growth
performance of immunologically stressed growing pigs

| Item | Control | Combo_1.0 | Combo_0.5 | PSE | P-value |
|---|---|---|---|---|---|
| # of Pens | 11 | 11 | 11 | | |
| # of Pigs | 235 | 243 | 223 | | |
| Start BW, lb | 61.5 | 62.0 | 61.8 | 1.2 | 0.59 |
| ADG, lb/day | 1.93 | 1.92 | 1.92 | 0.02 | 0.90 |
| ADFI, lb/day | 4.22 | 4.30 | 4.23 | 0.05 | 0.52 |
| Closeout F/G | 2.27 | 2.33 | 2.22 | 0.03 | 0.14 |
| BW end of | 213.4 | 211.6 | 210.7 | 1.5 | 0.61 |
| Wk 11, lb | | | | | |
| Mortality, % | 2.98^{c} | 2.53^{cd} | 0.82^{d} | N/A | 0.11 |
| Total | 6.38^{a} | 5.91^{a} | 2.47^{b} | N/A | 0.12 |
| removal, % | | | | | |

^{a, b}Means without a common superscript differ (P < 0.05)
^{c, d}Means without a common superscript tend to differ (P < 0.10)

### Example 4. Feeding a Full Components of Beta-Glucan/Yeast Cell Wall/Direct Fed Microbials/L-Carnitine Combination (Combo) Resulted in Better Growth Performance, Livability and Increased Circulating Vitamin A Concentration Compared to Feeding Partial Components to Nursery Pigs From 8 to 45 lb of BW

To evaluate the effects of dietary supplementation of the full vs. partial components of a beta-glucan/yeast cell wall/direct fed microbials/L-carnitine combination (Combo), a study was designed to feed the dietary treatments as shown Table 14 to nursery pigs from approximately 8 to 45 lb of BW post-weaning. Specifically, a total of 216 mixed-gender pigs were randomly placed in pens with 27 pigs per pen at weaning. Pens were blocked by weaning weight and pens within block were randomly assigned to one of 4 dietary treatments resulting in two pens per treatment. This study was conducted for 65 days in a 4-phase feeding program immediately after weaning. The composition of the basal diet is shown in Table 15. Vitamin A was supplemented as retinyl acetate in vitamin and trace mineral premix to provide 8,819.4 IU/kg of vitamin A in the diet, which was 4×times higher than the required vitamin A concentration (2,200 IU/kg) as described by National Research Council (NRC; 2012) for nursery pigs between 5 to 25 kg.

Analyses of Combo suggested that the concentrations of beta-glucan, total glucan and mannose were no less than 5.7%, 10.0%, and 9.0%, respectively. Concentration of DFM was no less than 7.5×108 cfu/g of the product. Dietary concentrations of beta-glucan, yeast cell wall, DFM and carnitine were the same for each of the treatments if included in the diets.

TABLE 14
Dietary treatments

| | | Inclusion |
|---|---|---|
| Treatment | Additive | Rate |
| 1. Control | None | N/A |
| 2. Yeast/DFM | Beta-glucan/yeast | 1.0 lb/ton |
| | cell wall/DFM | |
| 3. Carnitine | L-Carnitine | 50 ppm |
| 4. Combo | Beta-glucan/yeast | 1.0 lb/ton |
| | cell wall/DFM/ | |
| | carnitine | |

TABLE 15
Dietary composition of the basal diets

| | 9-15 lb | 15-22 lb | 22-37 lb | 37-52 lb |
|---|---|---|---|---|
| | Ph1CWG | Ph2CWG | Ph3CWG | Ph4CWG |
| Ingredient Name | | | | |
| Ground corn | 764.68 | 846.62 | 1033.37 | 977.88 |
| Distillers dried | 0.00 | 100.00 | 300.00 | 400.00 |
| grains | | | | |
| SBM 46% | 200.00 | 445.50 | 566.72 | 512.93 |
| PROTEIN | | | | |
| NQ Research | 950.00 | 475.00 | 0.00 | 0.00 |
| crumble basemix | | | | |
| BETAGRO | 6.00 | 3.00 | 0.00 | 0.00 |
| CHOICE WHITE | 20.00 | 50.59 | 47.85 | 49.65 |
| GREASE | | | | |
| LYSINE 98.5% | 6.59 | 6.43 | 9.22 | 9.67 |
| METHIONINE | 4.07 | 3.26 | 2.49 | 2.16 |
| 99% DL | | | | |
| Threonine 80% | 3.68 | 3.03 | 3.41 | 3.16 |
| TRYPTOPHAN | 1.01 | 0.66 | 0.82 | 0.89 |
| 98.5% | | | | |
| VALINE-L AEL | 1.02 | 0.00 | 0.00 | 0.00 |
| ISOLEUCINE L | 0.34 | 0.00 | 0.00 | 0.00 |
| LIMESTONE | 0.00 | 14.36 | 18.72 | 19.66 |
| 21% MONOCAL | 13.07 | 20.07 | 5.70 | 2.10 |
| SALT | 7.00 | 10.24 | 9.00 | 9.00 |
| Optiphos 2500 | 0.00 | 0.00 | 0.66 | 0.66 |
| CTC 90 | 6.70 | 8.90 | 0.00 | 6.70 |
| DENAGARD 10 | 3.50 | 0.00 | 0.00 | 3.50 |
| NHF Sow 4# VTM | 4.00 | 4.00 | 0.00 | 0.00 |
| NHF GF 2# VTM | 0.00 | 0.00 | 2.00 | 2.00 |
| ZnO | 8.30 | 8.30 | 0.00 | 0.00 |
| Microtracer Violet | 0.04 | 0.04 | 0.04 | 0.04 |
| Ingredient Total: | 2000.00 | 2000.00 | 2000.00 | 2000.00 |

Nutrient Name

| | | | | |
|---|---|---|---|---|
| Dry Matter, % | 88.77 | 88.45 | 87.76 | 87.98 |
| Mod ME, kcal/lb | 1507.93 | 1502.00 | 1500.00 | 1500.00 |
| Protein, % | 21.51 | 21.87 | 21.38 | 21.48 |
| Lysine, % | 1.56 | 1.52 | 1.47 | 1.45 |
| SID Lysine, % | 1.40 | 1.35 | 1.29 | 1.26 |
| SID Lys:ME g | 4.21 | 4.08 | 3.90 | 3.81 |
| Lys/mcal | | | | |
| SID m + c:Lys | 0.58 | 0.58 | 0.57 | 0.57 |
| SID Thr:Lys | 0.63 | 0.63 | 0.63 | 0.63 |
| SID Tryp:Lys | 0.20 | 0.20 | 0.20 | 0.20 |
| SID Iso:Lys | 0.60 | 0.62 | 0.60 | 0.60 |
| SID Val:Lys | 0.67 | 0.67 | 0.67 | 0.68 |
| Starch, % | 31.22 | 32.21 | 36.57 | 34.83 |
| Total Sugars, % | 4.13 | 5.76 | 7.05 | 6.94 |
| Lactose, % | 15.00 | 7.50 | 0.00 | 0.00 |
| ADF, % | 1.69 | 2.56 | 3.58 | 3.78 |
| NDF, % | 4.43 | 6.43 | 9.48 | 10.43 |
| Crude Fiber, % | 1.48 | 1.98 | 2.64 | 2.86 |
| Fat, % | 4.60 | 5.52 | 5.22 | 5.59 |
| IV, meq/kg f | 61.30 | 85.22 | 113.00 | 112.15 |
| IVP, actual | 21.44 | 38.37 | 48.68 | 51.73 |
| Ash, % | 6.08 | 6.43 | 4.58 | 4.55 |
| Calcium, % | 0.64 | 0.80 | 0.73 | 0.70 |
| Anzl | 0.63 | 0.80 | 0.55 | 0.52 |
| Calcium, % | | | | |
| Non Phytase | 0.14 | 0.37 | 0.32 | 0.30 |
| TTD Ca, % | | | | |
| Phytase | 0.00 | 0.00 | 0.03 | 0.03 |
| TTD Ca | | | | |
| TTD Ca, % | 0.14 | 0.37 | 0.35 | 0.33 |
| Ca STTD | 24.46 | 35.73 | 48.17 | 48.40 |
| Coeff, % | | | | |
| Phosphorus, % | 0.74 | 0.74 | 0.52 | 0.50 |
| Avail Phos | 0.50 | 0.46 | 0.40 | 0.38 |
| Equil, % | | | | |
| Non Phytase | 0.50 | 0.46 | 0.22 | 0.21 |
| aPhos, % | | | | |
| aP Release, % | 0.00 | 0.00 | 0.18 | 0.17 |
| P Available | 8.60 | 15.95 | 25.28 | 27.91 |
| Coeff, % | | | | |
| Phytase, FTU/kg | 0.00 | 0.00 | 827.43 | 750.58 |
| Non Phytase | 0.19 | 0.29 | 0.22 | 0.21 |
| TTD P, % | | | | |
| Phytase TTD P | 0.00 | 0.00 | 0.15 | 0.14 |
| TTD P, % | 0.19 | 0.29 | 0.37 | 0.35 |
| P STTD Coeff, % | 14.48 | 23.35 | 33.35 | 34.70 |
| AOAC PHYTASE, | 0.00 | 0.00 | 2068.56 | 1876.44 |
| FTU/kg | | | | |
| Phytate Phos | 0.24 | 0.28 | 0.30 | 0.29 |
| (Est.), % | | | | |
| calcium/aP, % | 0.51 | 18.18 | 23.55 | 24.64 |
| Salt, % | 0.34 | 0.50 | 0.44 | 0.44 |
| Sodium, % | 0.40 | 0.35 | 0.22 | 0.23 |
| Cholride, % | 0.67 | 0.59 | 0.43 | 0.44 |
| DDGS, % | 0.00 | 5.00 | 15.00 | 20.00 |

Serum samples were collected from two randomly selected pigs per pen with a total of 4 pigs per treatment at weaning (prior to access of the experimental diets) and at the end of the nursery phase when pigs reached approximately 45 lb of BW. Serum samples were analyzed for vitamin A concentration.

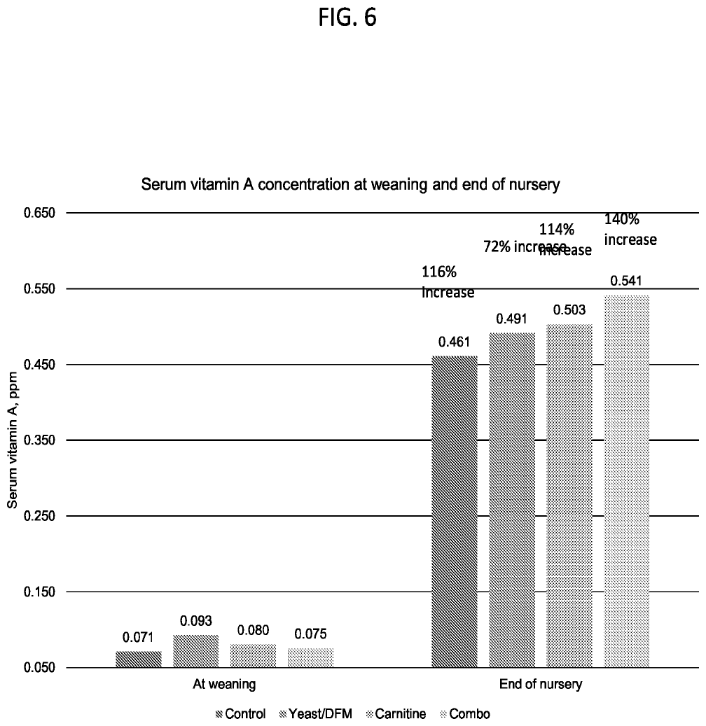

Results in FIG. 6 shows the average serum vitamin A concentration at weaning was 0.08 ppm which as 47% below the serum vitamin A sufficient level (0.15 ppm) as described by R. Puls (1994). The insufficient nutritional vitamin A status at weaning was likely due to the immune stress the pigs experienced during the weaning process. Pigs fed the Combo had the highest serum vitamin A concentration at the end of nursery (0.541 ppm) compared to pigs fed Control (0.461 ppm), Yeast/DFM (0.491 ppm) or carnitine (0.503 ppm) treatments. The percentage increases of serum vitamin A concentration from weaning to the end of nursery were 117, 72, 114 and 140% for Control, Yeast/DFM, camitine and Combo treatments, respectively (FIG. 6). Additionally, feeding Combo also showed the greatest improvement on the range of serum vitamin A concentrations (0.175-0.189 ppm) at the end of nursery phase compared to all other treatments (Table 16). Except for the Combo treatment, the minimum concentration of serum vitamin A at the end of nursery phase for the other three treatments were all below the sufficient level of 0.15 ppm, suggesting that although pigs were fed the diets sufficient in vitamin A, they could still develop vitamin A deficiency. These results suggested that dietary supplementation of Combo provided the greatest restoration of nutritional status of vitamin A post-weaning compared to Control, Yeast/DFM and carnitine treatments.

TABLE 16
Minimum, maximum and mean of serum vitamin A concentrations
in nursery pigs at weaning and end of nursery phase

| | At weaning | | | End of nursery | | |
|---|---|---|---|---|---|---|
| | Min. | Max. | Mean | Min. | Max. | Mean |
| Treatment | (ppm) | (ppm) | (ppm) | (ppm) | (ppm) | (ppm) |
| Control | 0.040 | 0.094 | 0.071 | 0.149 | 0.160 | 0.154 |
| Yeast/DFM | 0.066 | 0.117 | 0.095 | 0.147 | 0.174 | 0.164 |
| Carnitine | 0.064 | 0.102 | 0.078 | 0.143 | 0.198 | 0.168 |
| Combo | 0.045 | 0.111 | 0.075 | 0.175 | 0.189 | 0.180 |

The restoration of nutritional status of vitamin A by feeding Combo to newly weaned pigs resulted in synergistic effects on growth performance and livability compared to feeding partial components of Combo. Results from Table 17 suggest that feeding the full composition of Combo resulted in 129% and 108% greater nursery closeout ADG and closeout G/F, respectively, compared to Control. These improvements were greater than the additive effects of feeding Yeast/DFM (79% and 41%, respectively) or carnitine (29% and 29%, respectively) separately. Additionally, pigs on the full composition of Combo also showed the lowest mortality rate (P=0.14) compared to the pigs fed the partial composition of Combo and the Control treatments. The improvement on livability seems to be the greatest during the first 22-d post weaning when the nutritional status of circulating vitamin A was low due to immunological stress at weaning (FIG. 6).

TABLE 17
Effects of feeding a beta-glucan/yeast cell wall/direct fed
microbials/L-carnitine combination (Combo) or its individual components
on growth performance and livability of nursery pigs from 8 to 45 lb of BW
Effects of feeding a beta-glucan/yeast cell wall/direct fed microbials/L-carnitine combination (Combo) or its
individual components on growth performance and livability of nursery pigs from 8 to 45 lb of BW

| | Treatment | | | | | |
|---|---|---|---|---|---|---|
| Item | Control | Yeast/DFM | Carnitine | Combo | PSE | P-value |
| # of Pens | 2 | 2 | 2 | 2 | | |
| # of Pigs | 54 | 54 | 54 | 54 | | |
| Wean age, d | 21 | 21 | 21 | 21 | | |
| Start BW, lb | 8.0 | 8.1 | 8.2 | 8.4 | | |
| Early nursery; Phase 1 to 2; 22 d post-weaning | | | | | | |
| ADG, lb/day ¹ | 0.01 | 0.15 | 0.16 | 0.20 | 0.01 | 0.3010 |
| ADFI, lb/day ¹ | 0.75 | 0.66 | 0.68 | 0.73 | 0.04 | 0.2097 |
| G:F ¹ | 0.007 ^{a} | 0.217 ^{b} | 0.241 ^{b} | 0.273 ^{b} | 7.44 | <0.0001 |
| BW end of Phase 2, lb ¹ | 10.3 ^{a} | 13.5 ^{b} | 13.3 ^{b} | 14.1 ^{b} | 0.73 | 0.0050 |
| Mortality, % ¹ | 53.70 | 40.74 | 31.48 | 25.93 | 6.21 | 0.3610 |
| Late nursery; Phase 3 to 4; 43 d post-weaning | | | | | | |
| ADG, lb/day ¹ | 0.93 ^{d} | 0.83 ^{c,d} | 0.78 ^{c} | 1.00 ^{d} | 0.00 | 0.0578 |
| ADFI, lb/day ¹ | 1.52 ^{a,b} | 1.40 ª | 1.32 ª | 1.62 ^{b} | 0.06 | 0.0065 |
| F/G ¹ | 1.66 | 1.72 | 1.69 | 1.62 | 0.08 | 0.6281 |
| Closeout BW end of Phase 4, | 43.6 | 44.6 | 43.2 | 48.8 | 6.07 | 0.3300 |
| lb ¹ | | | | | | |
| Mortality, % ¹ | 9.26 | 9.26 | 14.81 | 9.26 | 5.38 | 0.6740 |
| Entire nursery; Phase 1 to 4; 65 d post-weaning | | | | | | |
| ADFI, lb/day ¹ | 1.08 ^{a,b} | 1.00 ^{a} | 1.01 ^{a} | 1.21 ^{b} | 0.05 | 0.0119 |
| ADG, lb/day ¹ | 0.24 ^{a} | 0.34 ^{a} | 0.31 ª | 0.55 ^{b} | 0.07 | 0.0141 |
| | | (+79%) | (+29%) | (129%) | | |
| G/F ¹ | 0.219 ^{b} | 0.308 ^{a,b} | 0.282 ^{b} | 0.455 ^{a} | 0.46 | 0.0286 |
| | | (+41%) | (+29%) | (+108%) | | |
| Mortality, % ¹ | 62.96 | 50.00 | 46.30 | 35.19 | 10.25 | 0.1438 |

individual components on growth performance and livability of nursery pigs from 8 to 45 lb of BW
^{a,b} Means without a common superscript differ (P < 0.05)
^{c,d} Means without a common superscript tend to differ (P < 0.10)
¹ Variable was analyzed by using non-parametric model.

Data in Table 18 suggest that feeding weanling pigs a diet containing Combo from 12 to 53 lb of BW at an inclusion level of 0.5 lb/ton of feed consistently and repeatably improved pig growth performance and livability. Specifically, nursery ADG of pigs fed Combo was improved each of the 3 studies by an average of 4.1% (0.76 vs. 0.73 lb/day; P<0.10) compared to Control in meta-analysis. Nursery feed conversion was improved in 2 out of 3 studies by an average of 1.2% (1.59 vs. 1.61; P=0.81) compared to Control. The greater ADG led to an average of 1.3 lb heavier closeout nursery BW (P=0.03) in pigs fed Combo compared to Control. Additionally, total removed pigs (sum of mortality and fallback pigs) were reduced from 12.9 to 10.6% (P=0.19) and medically treated pigs was reduced from 19.0 to 15.7% (P=0.10) in the Combo treatments compared to Control. This meta-analysis suggests that feeding Combo consistently and repeatably improved livability and growth performance in nursery pigs from 12 to 53 lb of BW. These beneficial effects in nursery pigs were likely driven by restored nutritional status of vitamin A post-weaning as shown in previous examples.

TABLE 18
Meta-analysis of feeding a beta-glucan/yeast cell wall/direct fed microbials/L-carnitine combination (Combo) to nursery pigs on growth
performance and livability

| | Meta-analysis | | | | Study 1 | | | | Study 2 | | | | Study 3 | | | |
|---|---|---|---|---|---|---|---|---|---|---|---|---|---|---|---|---|
| | Con- | Combo | | P- | Con- | Combo | | P- | Con- | Combo | | P- | Con- | Combo | | P- |
| Item | trol | 0.5 | SE | value | trol | 0.5 | SE | value | trol | 0.5 | SE | value | trol | 0.5 | SE | value |
| # of Studies | 3 | 3 | | | 1 | 1 | | | 1 | 1 | | | 1 | 1 | | |
| # of Pens | 30 | 30 | | | 12 | 12 | | | 10 | 10 | | | 8 | 8 | | |
| # of Pigs | 809 | 811 | | | 323 | 325 | | | 270 | 270 | | | 216 | 216 | | |
| Wean age, d | 18.4 | 18.4 | | | 15.6 | 15.6 | | | 19.7 | 19.7 | | | 19.8 | 19.8 | | |
| BW at | 12.0 | 12.0 | 0.3 | 0.94 | 10.9 | 10.9 | 0.3 | 0.98 | 13.2 | 13.2 | 0.3 | 0.95 | 12.49 | 12.41 | 0.22 | 0.47 |
| weaning, ¹lb | | | | | | | | | | | | | | | | |
| Early nursery | | | | | | | | | | | | | | | | |
| performance | | | | | | | | | | | | | | | | |
| ADG, lb/day | 0.38 | 0.41 | 0.01 | 0.04 | 0.36 | 0.39 | 0.01 | 0.03 | 0.42 | 0.44 | 0.02 | 0.45 | 0.38 | 0.43 | 0.02 | 0.15 |
| ADFI, lb/day | 0.66 | 0.68 | 0.02 | 0.41 | 0.70 | 0.70 | 0.02 | 0.17 | 0.64 | 0.73 | 0.02 | 0.004 | 0.67 | 0.63 | 0.04 | 0.51 |
| F/G | 1.79 | 1.72 | 0.05 | 0.25 | 1.99 | 1.84 | 0.04 | 0.009 | 1.50 | 1.69 | 0.07 | 0.01 | 1.77 | 1.49 | 0.09 | 0.05 |
| BW end of | 21.0 | 21.4 | 0.2 | 0.14 | 18.5 | 19.2 | 0.2 | 0.04 | 22.0 | 22.1 | 0.4 | 0.77 | 24.9 | 25.6 | 0.5 | 0.33 |
| Phase 2, lb | | | | | | | | | | | | | | | | |
| Mortality, % | 1.11 | 1.62 | N/A | 0.28 | 1.24 | 1.23 | N/A | 0.99 | 1.11 | 0.37 | N/A | 0.32 | 0.93 | 0.00 | N/A | 0.16 |
| Total removal, % | 8.53 | 5.92 | N/A | 0.05 | 2.17 | 2.46 | N/A | 0.81 | 10.00 | 6.67 | N/A | 0.18 | 16.2 | 10.2 | N/A | 0.09 |
| Treated pigs, % | 18.7 | 14.9 | N/A | 0.07 | 10.2 | 5.8 | N/A | 0.05 | 20.0 | 17.4 | N/A | 0.49 | 29.6 | 25.5 | N/A | 0.41 |
| Late nursery | | | | | | | | | | | | | | | | |
| performance | | | | | | | | | | | | | | | | |
| ADG, lb/day | 1.01 | 1.04 | 0.01 | 0.09 | 0.87 | 0.93 | 0.02 | 0.13 | 1.09 | 1.12 | 0.02 | 0.28 | 1.12 | 1.11 | 0.05 | 0.92 |
| ADFI, lb/day | 1.51 | 1.59 | 0.04 | 0.07 | 1.32 | 1.43 | 0.03 | 0.03 | 1.65 | 1.67 | 0.04 | 0.55 | 1.82 | 1.81 | 0.13 | 0.93 |
| F/G | 1.54 | 1.54 | 0.03 | 0.78 | 1.52 | 1.53 | 0.02 | 0.50 | 1.50 | 1.50 | 0.02 | 0.85 | 1.65 | 1.65 | 0.10 | 0.88 |
| BW end of | 52.1 | 53.4 | 0.4 | 0.03 | 43.4 | 45.5 | 0.5 | 0.02 | 58.6 | 59.6 | 0.7 | 0.30 | 56.1 | 56.7 | 1.7 | 0.75 |
| nursery, lb | | | | | | | | | | | | | | | | |
| Mortality, % | 1.36 | 0.74 | N/A | 0.22 | 2.17 | 0.62 | N/A | 0.09 | 0.00 | 0.74 | N/A | 0.16 | 1.85 | 0.93 | N/A | 0.41 |
| Total removal, % | 4.33 | 4.69 | N/A | 0.73 | 3.10 | 2.15 | N/A | 0.46 | 3.70 | 5.56 | N/A | 0.32 | 6.94 | 7.41 | N/A | 0.86 |
| Treated pigs, % | 0.37 | 0.74 | N/A | 0.32 | 0.31 | 0.62 | N/A | 0.57 | 0.00 | 0.74 | N/A | 0.16 | 0.93 | 0.93 | N/A | 1.00 |
| Entire nursery | | | | | | | | | | | | | | | | |
| performance | | | | | | | | | | | | | | | | |
| ADG, lb/day | 0.73 | 0.76 | 0.01 | 0.01 | 0.65 | 0.69 | 0.01 | 0.03 | 0.82 | 0.84 | 0.01 | 0.19 | 0.74 | 0.77 | 0.03 | 0.48 |
| ADFI, lb/day | 1.12 | 1.17 | 0.03 | 0.09 | 1.05 | 1.11 | 0.02 | 0.08 | 1.24 | 1.29 | 0.03 | 0.13 | 1.25 | 1.23 | 0.09 | 1.90 |
| F/G | 1.61 | 1.59 | 0.03 | 0.81 | 1.63 | 1.60 | 0.01 | 0.05 | 1.51 | 1.54 | 0.02 | 0.30 | 1.68 | 1.61 | 0.09 | 0.57 |
| Closeout ADG, | 0.69 | 0.72 | 0.01 | 0.02 | 0.63 | 0.68 | 0.01 | 0.04 | 0.79 | 0.81 | 0.02 | 0.34 | 0.67 | 0.71 | 0.03 | 0.38 |
| lb/day | | | | | | | | | | | | | | | | |
| Closeout F/G | 1.71 | 1.67 | 0.03 | 0.32 | 1.67 | 1.63 | 0.02 | 0.14 | 1.57 | 1.60 | 0.03 | 0.20 | 1.87 | 1.73 | 0.09 | 0.26 |
| BW end of | 52.1 | 53.4 | 0.4 | 0.03 | 13.4 | 45.5 | 0.5 | 0.02 | 58.6 | 59.6 | 0.7 | 0.30 | 56.1 | 56.7 | 1.7 | 0.75 |
| nursery, lb | | | | | | | | | | | | | | | | |
| Mortality, % | 2.47 | 1.36 | N/A | 0.10 | 3.41 | 1.85 | N/A | 0.22 | 1.11 | 1.11 | N/A | 1.00 | 2.78 | 0.93 | N/A | 0.16 |
| Total removal, % | 12.9 | 10.6 | N/A | 0.19 | 5.26 | 4.62 | N/A | 0.71 | 13.7 | 12.2 | N/A | 0.63 | 23.1 | 17.6 | N/A | 0.20 |
| Treated pigs, % | 19.0 | 15.7 | N/A | 0.10 | 10.5 | 6.5 | N/A | 0.08 | 20.0 | 18.1 | N/A | 0.62 | 30.6 | 26.4 | N/A | 0.42 |

¹BW at weaning was used as covariate for all analyses

1. A method of improving a nutritional status of an immunologically stressed non-human animal in need thereof, the method comprising orally administering to the animal a composition comprising beta-glucan, yeast cell wall, direct fed microbials (Yeast+DFM), and L-carnitine, wherein improving the nutritional status of the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal.

2. The method of claim 1, wherein the insufficient levels of vitamin A are below about 0.15 ppm and the sufficient levels of vitamin A are about 0.15 ppm or above, from about 0.15 ppm to about 0.2 ppm, or about 0.2 ppm or above.

3. The method of claim 1, wherein the animal is immunologically stressed animal in response to a challenge.

4. The method of claim 1, wherein the animal is immunologically stressed in response to a stressor selected from microbial infection, induced inflammation (vaccination), psychological trauma (weaning), and physical trauma.

5. The method of claim 1, wherein the animal is immunologically stressed in response to weaning.

6. The method of claim 1, wherein the animal is immunologically stressed in response to vaccination.

7. The method of claim 3, wherein the composition is administered to the animal starting at weaning.

8. The method of claim 1, wherein administering the Yeast+DFM in combination with L-carnitine to the animal improves growth performance and survivability of the animal.

9. The method of claim 1, wherein growth performance comprises ADG and feed conversion.

10. The method of claim 1, wherein the animal is a pig.

11. The method of claim 1, wherein the feed composition comprises Yeast, DFM, L-carnitine at rates of about 89%, about 1%, about 10% respectively in the supplement.

12. The method of claim 1, wherein the composition is administered in a feed composition at an inclusion rate ranging from about 0.3 lb/ton to about 0.6 lb/ton, or at an inclusion rate ranging from about 0.9 lb/ton to about 1.1 lb/ton.

13. A method of improving growth performance and survivability of an animal in need thereof, the method comprising orally administering to the animal a composition comprising beta-glucan, yeast cell wall, direct fed microbials (Yeast+DFM), and L-carnitine, wherein improving growth performance and survivability of the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal.

14. The method of claim 13, wherein the animal is immunologically stressed.

15. A method of reducing immunological stress in an animal in need thereof, the method comprising orally administering to the animal a composition comprising beta-glucan, yeast cell wall, direct fed microbials (Yeast+DFM), and L-carnitine, wherein reducing immunological stress in the animal comprises restoring an insufficient level of circulating vitamin A in the animal to sufficient levels of circulating vitamin A, and wherein administering the Yeast+DFM in combination with L-carnitine results in a synergistic restoration of the insufficient level of circulating vitamin A in the animal.

16. The method of claim 15, wherein the insufficient levels of vitamin A are below about 0.15 ppm and the sufficient levels of vitamin A are about 0.15 ppm or above, from about 0.15 ppm to about 0.2 ppm, or about 0.2 ppm or above.

17. (canceled)

18. The method of claim 15, wherein the animal is immunologically stressed animal in response to a challenge.

19. The method of claim 15, wherein the animal is immunologically stressed in response to a stressor selected from microbial infection, induced inflammation (vaccination), psychological trauma (weaning), and physical trauma.

20. The method of claim 15, wherein the animal is immunologically stressed in response to weaning.

21. The method of claim 15, wherein the animal is immunologically stressed in response to vaccination.
